(19) United States
(12) Patent Application Publication
(10) Pub. No.: US 2024/0195579 A1
(43) Pub. Date: Jun. 13, 2024

(54) METHOD AND DEVICE IN NODES USED FOR WIRELESS COMMUNICATION

(71) Applicants: Keying WU, Shanghai (CN); Xiaobo ZHANG, Shanghai (CN)

(72) Inventors: Keying WU, Shanghai (CN); Xiaobo ZHANG, Shanghai (CN)

(73) Assignee: SHANGHAI LANGBO COMMUNICATION TECHNOLOGY COMPANY LIMITED, Shanghai, OT (CN)

(21) Appl. No.: 18/581,401

(22) Filed: Feb. 20, 2024

Related U.S. Application Data
(63) Continuation of application No. PCT/CN2022/112663, filed on Aug. 16, 2022.

(30) Foreign Application Priority Data
Aug. 20, 2021 (CN) 202110959420.2

(51) Int. Cl. H04L 5/00

(52) U.S. Cl. CPC H04L 5/0053

(57) ABSTRACT

A first node transmits a first signal; and receives a first signaling; and monitors a first-type channel in a first resource subset with same spatial parameters as a target reference signal after first time. The first signal is used to indicate a first reference signal; the first signaling is used to determine the first time; the first reference signal is one of M reference signals; whether the target reference signal is the first reference signal is related to type(s) of channel(s) carrying the first signal; when the type(s) of the channel(s) carrying the first signal includes a first type, the target reference signal is the first reference signal; otherwise, whether the target reference signal is the first reference signal is related to the first reference signal. The method ensures that a specific CORESET, e.g. CORESET 0, always works at the optimal beam in multi-TRP scenarios.

### CROSS REFERENCE TO RELATED APPLICATIONS

This application is the continuation of the international patent application No. PCT/CN2022/112663, filed on Aug. 16, 2022, and claims the priority benefit of Chinese Patent Application No. 202110959420.2, filed on Aug. 20, 2021, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

The Multi-antenna technique is a crucial part in the 3rd Generation Partner Project (3GPP) Long-term Evolution (LTE) and New Radio (NR) systems. More than one antenna can be configured, at the communication node. e.g., a base station or a User Equipment (UE), to obtain extra degree of freedom in space. Multiple antennas form through beamforming a beam pointing in a specific direction to enhance the communication quality. When the multiple antennas belong to multiple Transmitter Receiver Points (TRPs)/panels, spatial differences between TRPs/panels can be taken advantage of to obtain extra diversity gains. In NR R (release) R16, multi-TRP based repeated transmission is used to improve the transmission reliability of downlink physical layer data channels.

Massive MIMO technology is one of the key technologies in NR systems, where a large-scale antenna matrix forms a narrow beam through beamforming, which concentrates the energy in a specific direction and thus can enhance the communication quality. Due to the narrow beam formed by the large-scale antenna matrix, beams from the two sides of the communication need to be aligned to ensure efficient communications. For this purpose, the NR system introduces a beam management mechanism, as well as a mechanism to quickly detect beam failure and perform beam recovery.

### SUMMARY

In combination with beam-based multi-antenna technology and multi-TRP transmission, the beam management, failure detection and recovery mechanisms in NR R16 need to be extended to a multi-TRP architecture. The mechanism for beam failure detection/recovery per TRP is accepted in the discussions of R17. How the introduction of a per-TRP beam failure detection/recovery mechanism affects the subsequent processing that needs to be performed by the UE after beam failure recovery is an issue that needs to be addressed, including, but not limited to, of which COntrol REsource SETs (CORESETs) the Transmission Configuration Indicator (TCI) states need to be updated with the new beams after recovery, and whether the TCI states of CORESETs with index 0 need to be updated with the new beam.

To address the above problem, the present application provides a solution. It should be noted that although the description above only took cellular networks and multi-TRP as an example, the present application also applies to other scenarios like Sidelink transmission and single-TRP, where similar technical effects can be achieved. Additionally, the adoption of a unified solution for various scenarios, including but not limited to cellular networks, and sidelink transmission as well as multi-TRP and single-TRP, contributes to the reduction of hardcore complexity and costs. In the case of no conflict, the embodiments of a first node and the characteristics in the embodiments may be applied to a second node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
transmitting a first signal, the first signal used to indicate a first reference signal;
receiving a first signaling, the first signaling used to determine a first time: and
monitoring a first-type channel in a first resource subset with same spatial parameters as those of a target reference signal after the first time;
herein, the first reference signal is one of M reference signals. M being a positive integer greater than 1; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

In one embodiment, the problem to be addressed by the present application includes: when the beam failure detection and recovery mechanism is extended to multiple TRPs, what are the implications for subsequent processing after beam failure recovery, including but not limited to TCI states of which CORESETs need to be updated based on the recovered new beam. The above-described method solves this problem by determining which of the TCI states of the CORESETs need to be updated based on the type of a channel occupied by a signal indicating the recovered new beam.

In one embodiment, the characteristics of the above method include: the first signal being used to indicate a new beam after recovery, the first resource subset belonging to a specific CORESETSET: and whether or not the TCI state of the first resource subset is updated by the first signal being related to the type of the channel carrying the first signal.

In one embodiment, the characteristics of the above method include: the type of the channel carrying the first signal being used to indicate whether the beam failure occurred in all or part of the TRP, and accordingly determine which of the CORESET TCI states are updated.

In one embodiment, an advantage of the above method includes: in a multi-TRP scenario, a specific CORESETSET, such as a CORESET with index 0, is guaranteed to always operate under optimal beams, hence the transmission reliability in the specific CORESETSET.

In one embodiment, an advantage of the above method includes: an implicit indication of which CORESET's TCI state is updated by a new beam after beam failure recovery, reducing signaling overhead.

According to one aspect of the present application, characterized in comprising:
monitoring the first-type channel in a second resource subset before the first time;
herein, before the first time, the same spatial parameters as those of a second reference signal are assumed for the monitoring of the first-type channel in the second resource subset.

According to one aspect of the present application, characterized in comprising:
receiving a second signaling in the first resource subset after the first time;
herein, the second signaling comprises a second field, the value of the second field in the second signaling being related to a number of first-type signalings transmitted in a target resource set group, the target resource set group being a first resource set group or a second resource set group; the value of the second field in the second signaling is unrelated to a number of first-type signalings transmitted in a resource set group of the first resource set group and the second resource set group other than the target resource set group; when the target reference signal is the first reference signal, the first reference signal is used to determine the target resource set group.

According to one aspect of the present application, characterized in comprising:
receiving a third signaling after the first time;
herein, the third signaling comprises a MAC CE or a DCI; the third signaling comprises a third field and a fourth field, the third field in the third signaling indicating a given CORESET, and the fourth field in the third signaling indicating an index of a CORESET pool corresponding to the given CORESET.

According to one aspect of the present application, characterized in that the M reference signals include a first reference signal subset and a second reference signal subset; when the type/types of the channel/channels carrying the first signal does/do not include the first type, whether the target reference signal is the first reference signal is related to whether the first reference signal belongs to the first reference signal subset or the second reference signal subset.

In one embodiment, an advantage of the above method includes: reducing unnecessary TCI state updates to CORESETs with index 0, thus reducing the system complexity while ensuring transmission reliability in the CORESETs with index 0.

According to one aspect of the present application, characterized in comprising:
receiving the M reference signals, measurements of the M reference signals being respectively used to determine M first-type received qualities;
herein, the M first-type received qualities are used to determine the first reference signal.

According to one aspect of the present application, characterized in that the M reference signals include a first reference signal subset and a second reference signal subset; when and only when a first condition is satisfied, the first reference signal belongs to the second reference signal subset; the first condition is related to a first-type received quality corresponding to each reference signal in the first reference signal subset.

In one embodiment, the characteristics of the above method include: when beam failure occurs in all TRPs, a beam in the TRP to which a CORESET with index 0 currently belongs is preferentially selected as the new beam; the advantages of the above method include: minimizing unnecessary TRP switching for the CORESET with index 0 and reducing system complexity

According to one aspect of the present application, characterized in comprising:
receiving a first reference signal subgroup and a second reference signal subgroup, a measurement of the first reference signal subgroup being used to determine a first received quality subgroup, while a measurement of the second reference signal subgroup being used to determine a second received quality subgroup, each of the first reference signal subgroup and the second reference signal subgroup respectively comprising at least one reference signal, and each of the first received quality subgroup and the second received quality subgroup respectively comprising at least one second-type received quality;
where the first received quality subgroup and the second received quality subgroup are used to determine whether a second condition set is satisfied, and whether the second condition set is satisfied is used to determine whether the first signal is to be transmitted.

According to one aspect of the present application, characterized in comprising:
monitoring the first-type channel in a target resource set group with same spatial parameters as those of the first reference signal after the first time;
where the target resource set group is a first resource set group or a second resource set group; the first reference signal is used to determine the target resource set group.

According to one aspect of the present application, characterized in comprising:
receiving a first information block;
herein, the first information block is used to determine the M reference signals.

According to one aspect of the present application, the first node is a UE.

According to one aspect of the present application, the first node is a relay node.

The present application provides a method in a second node for wireless communications, comprising:
receiving a first signal, the first signal used to indicate a first reference signal;
transmitting a first signaling, the first signaling used to determine a first time; and
transmitting a first-type channel in a first resource subset after the first time;
herein, the first reference signal is one of M reference signals. M being a positive integer greater than 1; after the first time, a transmitter of the first signal monitors the first-type channel in the first resource subset with same spatial parameters as those of a target reference signal; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

According to one aspect of the present application, characterized in comprising:
transmitting the first-type channel in a second resource subset before the first time;
herein, a transmitter of the first signal monitors the first-type channel in the second resource subset with same spatial parameters as those of a second reference signal before the first time.

According to one aspect of the present application, characterized in comprising:
transmitting a second signaling in the first resource subset after the first time;
herein, the second signaling comprises a second field, the value of the second field in the second signaling being related to a number of first-type signalings transmitted in a target resource set group, the target resource set group being a first resource set group or a second resource set group; the value of the second field in the second signaling is unrelated to a number of first-type signalings transmitted in a resource set group of the first resource set group and the second resource set group other than the target resource set group; when the target reference signal is the first reference signal, the first reference signal is used to determine the target resource set group.

According to one aspect of the present application, characterized in comprising:
transmitting a third signaling after the first time;
herein, the third signaling comprises a MAC CE or a DCI; the third signaling comprises a third field and a fourth field, the third field in the third signaling indicating a given CORESET, and the fourth field in the third signaling indicating an index of a CORESET pool corresponding to the given CORESET.

According to one aspect of the present application, characterized in that the M reference signals include a first reference signal subset and a second reference signal subset; when the type/types of the channel/channels carrying the first signal does/do not include the first type, whether the target reference signal is the first reference signal is related to whether the first reference signal belongs to the first reference signal subset or the second reference signal subset.

According to one aspect of the present application, characterized in comprising:

transmitting the M reference signals, measurements of the M reference signals being respectively used to determine M first-type received qualities:

herein, the M first-type received qualities are used to determine the first reference signal.

According to one aspect of the present application, characterized in that the M reference signals include a first reference signal subset and a second reference signal subset; when and only when a first condition is satisfied, the first reference signal belongs to the second reference signal subset; the first condition is related to a first-type received quality corresponding to each reference signal in the first reference signal subset.

According to one aspect of the present application, characterized in comprising:
transmitting a first reference signal subgroup and a second reference signal subgroup, a measurement of the first reference signal subgroup being used to determine a first received quality subgroup, while a measurement of the second reference signal subgroup being used to determine a second received quality subgroup, each of the first reference signal subgroup and the second reference signal subgroup respectively comprising at least one reference signal, and each of the first received quality subgroup and the second received quality subgroup respectively comprising at least one second-type received quality;
where the first received quality subgroup and the second received quality subgroup are used to determine whether a second condition set is satisfied, and whether the second condition set is satisfied is used to determine whether the first signal is to be transmitted.

According to one aspect of the present application, characterized in comprising:
transmitting the first-type channel in a target resource set group after the first time;
herein, a transmitter of the first signal monitors the first-type channel in the target resource set group with same spatial parameters as those of the first reference signal after the first time: the target resource set group is a first resource set group or a second resource set group; the first reference signal is used to determine the target resource set group.

According to one aspect of the present application, characterized in comprising:
transmitting a first information block;
herein, the first information block is used to determine the M reference signals.

According to one aspect of the present application, the second node is a base station.

According to one aspect of the present application, the second node is a UE.

According to one aspect of the present application, the second node is a relay node.

The present application provides a first node for wireless communications, comprising:
a first transmitter, transmitting a first signal, the first signal used to indicate a first reference signal; and
a first receiver, receiving a first signaling, the first signaling being used to determine a first time;
the first receiver, monitoring a first-type channel in a first resource subset with same spatial parameters as those of a target reference signal after the first time;
herein, the first reference signal is one of M reference signals, M being a positive integer greater than 1; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

The present application provides a second node for wireless communications, comprising:
a second receiver, receiving a first signal, the first signal used to indicate a first reference signal; and
a second transmitter, transmitting a first signaling, the first signaling used to determine a first time;
the second transmitter, transmitting a first-type channel in a first resource subset after the first time;
herein, the first reference signal is one of M reference signals. M being a positive integer greater than 1; after the first time, a transmitter of the first signal monitors the first-type channel in the first resource subset with same spatial parameters as those of a target reference signal; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

In one embodiment, compared with the prior art, the present application is advantageous in the following aspects:
in a multi-TRP scenario, a specific CORESETSET, such as a CORESET with index 0, is guaranteed to always operate under optimal beams, hence the transmission reliability in the specific CORESETSET;
whether the TCI state of a specific CORESETSET, such as a CORESET with index 0 is updated by a new beam after beam failure recovery is indicated implicitly, which reduces the signaling overhead.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of a first signal, a first signaling and a first-type channel according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission according to one embodiment of the present application.

FIG. 6 illustrates a schematic diagram of a first resource subset according to one embodiment of the present application.

FIG. 7 illustrates a schematic diagram of a first node monitoring a first-type channel in a first resource subset with the same spatial parameters as those of a target reference signal after first time according to one embodiment of the present application.

FIG. 8 illustrates a schematic diagram of time-frequency resources occupied by a first signaling belonging to a second resource set according to one embodiment of the present application.

FIG. 9 illustrates a schematic diagram of whether a target reference signal is a first reference signal relating to the type(s) of channel(s) carrying a first signal according to one embodiment of the present application.

FIG. 10 illustrates a schematic diagram of whether a target reference signal is a first reference signal relating to the type(s) of channel(s) carrying a first signal according to one embodiment of the present application.

FIG. 11 illustrates a schematic diagram of M reference signals and M first-type received qualities according to one embodiment of the present application.

FIG. 12 illustrates a schematic diagram of a first condition and a first reference signal according to one embodiment of the present application.

FIG. 13 illustrates a schematic diagram of a first reference signal subgroup, a second reference signal subgroup, a first received quality subgroup and a second received quality subgroup according to one embodiment of the present application.

FIG. 14 illustrates a schematic diagram of a first received quality subgroup, a second received quality subgroup, a second condition set and a first signal according to one embodiment of the present application.

FIG. 15 illustrates a schematic diagram of a first node monitoring a first-type channel in a target resource set group with the same spatial parameters as those of a first reference signal after first time according to one embodiment of the present application.

FIG. 16 illustrates a schematic diagram of a first information block being used to determine M reference signals according to one embodiment of the present application.

FIG. 17 illustrates a structure block diagram of a processing device in a first node according to one embodiment of the present application.

FIG. 18 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

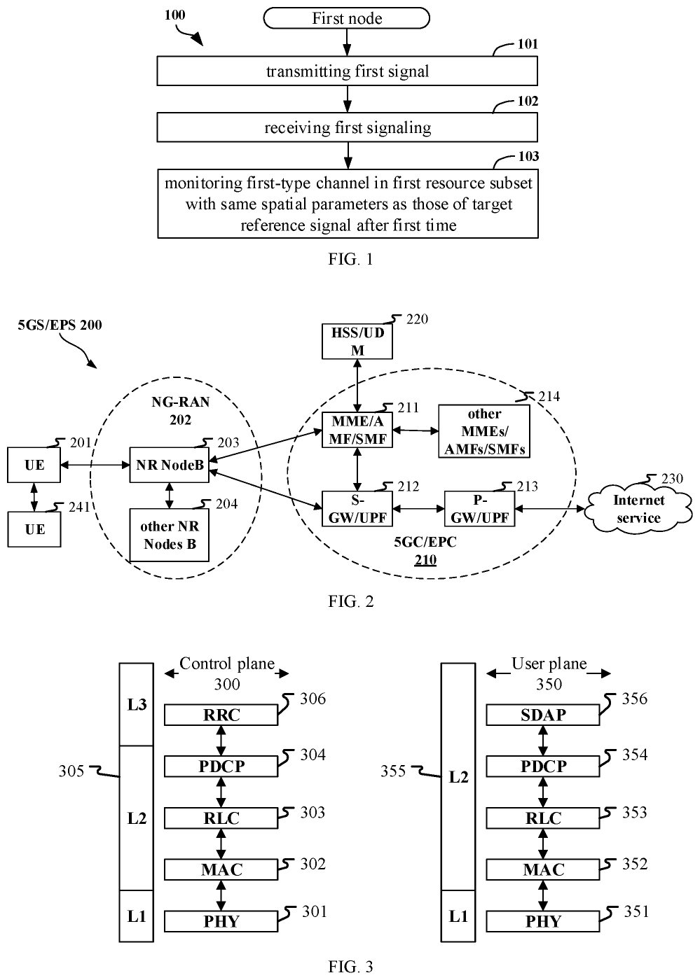

Embodiment 1 illustrates a flowchart of a first signal, a first signaling and a first-type channel according to one embodiment of the present application, as shown in FIG. 1. In 100 illustrated by FIG. 1, each box represents a step. Particularly, the sequential step arrangement in each box herein does not imply a chronological order of steps marked respectively by these boxes.

In Embodiment 1, the first node in the present application transmits a first signal in step 101, the first signal used to indicate a first reference signal; and receives a first signaling in step 102, the first signaling used to determine a first time: and in step 103, monitors a first-type channel in a first resource subset with same spatial parameters as those of a target reference signal after the first time; herein, the first reference signal is one of M reference signals. M being a positive integer greater than 1; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

In one embodiment, the first signal comprises a baseband signal.

In one embodiment, the first signal comprises a radio signal.

In one embodiment, the first signal comprises a radio frequency signal.

In one embodiment, the first signal comprises a Random Access Preamble.

In one embodiment, the Random Access Preamble comprises one or more of a pseudo-random sequence, a Zadoff-Chu sequence or a low-Peak-to-Average Power Ratio (low-PAPR) sequence.

In one embodiment, the Random Access Preamble comprises a Cyclic Prefix (CP).

In one embodiment, the first signal comprises a Physical Random Access CHannel (PRACH) Preamble.

In one embodiment, the first signal comprises a contention-free PRACH preamble.

In one embodiment, the first signal comprises a contention-based PRACH preamble.

In one embodiment, the first signal comprises a PRACH preamble used for a Beam Failure Recovery Request.

In one embodiment, the first signal comprises Uplink control information (UCI).

In one embodiment, the first signal comprises a Link Recovery Request (LRR).

In one embodiment, the first signal comprises a Medium Access Control layer Control Element (MAC CE).

In one embodiment, the first signal is a MAC CE.

In one embodiment, the first signal comprises a Beam Failure Recovery (BFR) MAC CE or a Truncated BFR MAC CE.

In one embodiment, the first signal comprises all or partial information of a BFR MAC CE or a Truncated BFR MAC CE.

In one embodiment, the first signal comprises a PRACH Preamble or a MAC CE.

In one embodiment, a channel occupied by the first signal includes a PRACH.

In one embodiment, a channel occupied by the first signal includes a Physical Uplink Shared CHannel (PUSCH).

In one embodiment, a channel occupied by the first signal includes a Physical Uplink Control Channel (PUCCH).

In one embodiment, radio resources occupied by the first signal comprise a PRACH resource.

In one embodiment, the first signal indicates the first reference signal.

In one embodiment, a PRACH resource occupied by the first signal is used to indicate the first reference signal.

In one embodiment, a PRACH resource occupied by the first signal belongs to a first PRACH resource set of M PRACH resource sets; the M PRACH resource sets respectively correspond to the M reference signals; the first reference signal is a reference signal corresponding to the first PRACH resource set among the M reference signals:

any of the M PRACH resource sets comprises at least one PRACH resource.

In one embodiment, the M PRACH resource sets are configured by a higher layer parameter.

In one embodiment, a name of a higher layer parameter configuring the M PRACH resource sets includes “candidateBeamRS”.

In one embodiment, a PRACH resource comprises a PRACH occasion.

In one embodiment, a PRACH resource comprises a PRACH preamble.

In one embodiment, a PRACH resource comprises a PRACH preamble index.

In one embodiment, a PRACH resource comprises time-frequency resources.

In one embodiment, a PRACH preamble comprised by the first signal is one of M PRACH preambles, the M PRACH preambles respectively corresponding to the M reference signals; the first reference signal is a reference signal corresponding to the PRACH preamble comprised by the first signal among the M reference signals.

In one embodiment, the M PRACH preambles are configured by a higher layer parameter.

In one embodiment, a name of a higher layer parameter configuring the M PRACH preambles includes “candidateBeamRS”.

In one embodiment. M is no greater than 16.

In one embodiment. M is no greater than 64.

In one embodiment. M is no greater than 128.

In one embodiment, the first signal comprises a first field, the first field comprising at least one bit; a value of the first field in the first signal indicates the first reference signal.

In one embodiment, the first signaling comprises a physical-layer signaling.

In one embodiment, the first signaling is a physical layer signaling.

In one embodiment, the first signaling comprises a dynamic signaling.

In one embodiment, the first signaling comprises a layer 1 (L1) signaling.

In one embodiment, the first signaling comprises Downlink Control Information (DCI).

In one embodiment, the first signaling is DCI.

In one embodiment, the first signaling comprises DCI for DL Grant.

In one embodiment, the first signaling comprises DCI for UL Grant.

In one embodiment. Cyclic Redundancy Check (CRC) of the first signaling is scrambled by a Cell-Radio Network Temporary Identifier (C-RNTI).

In one embodiment. CRC of the first signaling is scrambled by a Modulation and Coding Scheme (MCS)-C-RNTI.

In one embodiment, when the channel carrying the first signal includes a PRACH, the first signaling comprises a DCI for downlink grant or a DCI for uplink grant: when the channel carrying the first signal is a PUSCH, the first signaling comprises a DCI for uplink grant.

In one embodiment, a search space set to which the first signaling belongs is identified by a recovery SearchSpaceId.

In one embodiment, an index of a search space set to which the first signaling belongs is configured by a higher-layer parameter, where a name of the higher-layer parameter includes “recovery SearchSpace”.

In one subembodiment, the higher-layer parameter is “recovery SearchSpaceId”.

In one embodiment, a search space set to which the first signaling belongs is different from a search space set identified by a recovery SearchSpaceId.

In one embodiment, the first signal is transmitted in a first PUSCH, and the first signaling schedules transmission of a PUSCH with the same Hybrid Automatic Repeat reQuest (HARQ) process number and toggled New Data Indicator (NDI) field value as the first PUSCH.

In one embodiment, time-frequency resources of the first signaling and the first resource subset belong to a same CORESET.

In one embodiment, time-frequency resources of the first signaling and the first resource subset belong to different CORESETs.

In one embodiment, time-frequency resources of the first signaling and the first resource subset belong to a same search space set.

In one embodiment, time-frequency resources of the first signaling and the first resource subset belong to different search space sets.

In one embodiment, a search space set to which the first signaling belongs is related to the type/types of the channel/channels carrying the first signaling.

In one embodiment, when the type/types of the channel/channels carrying the first signaling includes/include the first type, a search space set to which the first signaling belongs is identified by a recovery SearchSpaceId: when the type/types of the channel/channels carrying the first signaling does/do not include the first type, the search space set to which the first signaling belongs is different from a search space set identified by a recovery SearchSpaceId.

In one embodiment, time-domain resources occupied by the first signaling are used to determine the first time.

In one embodiment, a time interval between the first time and time-domain resources occupied by the first signaling is a first interval: the first interval is a non-negative integer.

In one embodiment, the first time is a start time of a first symbol after a first interval following a last symbol occupied by the first signaling.

In one embodiment, the first interval is a positive integer.

In one embodiment, the first interval is measured in symbols.

In one embodiment, the first interval is measured in milliseconds (ms).

In one embodiment, the first interval is measured in slots.

In one embodiment, the first interval is pre-defined.

In one embodiment, the first interval is not in need of configuration.

In one embodiment, the first interval is fixed.

In one embodiment, the first interval is fixed to 28 symbols.

In one embodiment, the symbol is an Orthogonal Frequency Division Multiplexing (OFDM) Symbol.

In one embodiment, the symbol is a Single Carrier-Frequency Division Multiple Access (SC-FDMA) symbol.

In one embodiment, the first time is related to the type of the channel carrying the first signal.

In one embodiment, the type of the channel carrying the first signal is used to determine the first interval.

In one embodiment, when the type/types of the channel/channels carrying the first signal includes/include the first type, the first interval is equal to a third integer: when the type/types of the channel/channels carrying the first signal does/do not include the first type, the first interval is equal to a fourth integer: the third integer is unequal to the fourth integer.

In one embodiment, the first-type channel includes a physical layer channel.

In one embodiment, the first-type channel is a physical layer channel.

In one embodiment, the first-type channel comprises a layer 1 (L1) channel.

In one embodiment, the first-type channel comprises a downlink physical layer control channel (i.e., a downlink channel only capable of bearing physical layer signaling).

In one embodiment, the first-type channel includes a Physical Downlink Control Channel (PDCCH).

In one embodiment, the first-type channel is a PDCCH.

In one embodiment, the phrase of monitoring a first-type channel means: monitoring a DCI format transmitted in the first-type channel.

In one embodiment, the phrase of monitoring a first-type channel means: detecting a DCI format by monitoring the first-type channel.

In one embodiment, the phrase of monitoring a first-type channel means: monitoring a PDCCH candidate to determine whether the first-type channel is transmitted.

In one embodiment, the phrase of monitoring a first-type channel means: monitoring a PDCCH candidate to determine whether a DCI format is transmitted in the PDCCH candidate in the first-type channel.

In one embodiment, the phrase of monitoring a first-type channel means: performing decoding: if decoding is determined to be correct according to a CRC, it is then determined that the first-type channel is detected: otherwise, it is determined that the first-type channel is not detected.

In one embodiment, the phrase of monitoring a first-type channel means: performing decoding: if decoding is determined to be correct according to a CRC, it is then determined that a DCI format is detected to be transmitted in the first-type channel: otherwise, it is determined that no DCI format is detected.

In one embodiment, the phrase of monitoring a first-type channel means: performing coherent detection: if the signal energy obtained after the coherent detection is greater than a first given threshold, it is then determined that a DCI format is detected to be transmitted in the first-type channel: otherwise, it is determined that no DCI format is detected.

In one embodiment, the phrase of monitoring a first-type channel means: performing energy detection: if the signal energy obtained after the energy detection is greater than a second given threshold, it is then determined that a DCI format is detected to be transmitted in the first-type channel: otherwise, it is determined that no DCI format is detected.

In one embodiment, the phrase of monitoring a first-type channel means: determining according to CRC whether the first-type channel is transmitted, and being unsure of whether the first-type channel is to be transmitted before determining whether decoding is correct according to CRC.

In one embodiment, the phrase of monitoring a first-type channel means: determining according to CRC whether there exists a DCI being transmitted in the first-type channel, and being unsure of whether there exists a DCI being transmitted in the first-type channel before determining whether decoding is correct according to CRC.

In one embodiment, the phrase of monitoring a first-type channel means: determining according to coherent detection whether there exists a DCI being transmitted in the first-type channel, and being unsure of whether there exists a DCI being transmitted in the first-type channel before the coherent detection.

In one embodiment, the phrase of monitoring a first-type channel means: determining according to energy detection whether there exists a DCI being transmitted in the first-type channel, and being unsure of whether there exists a DCI being transmitted in the first-type channel before the energy detection.

In one embodiment, the first reference signal comprises a Channel State Information-Reference Signal (CSI-RS).

In one embodiment, the first reference signal comprises a periodic CSI-RS.

In one embodiment, the first reference signal comprises a Synchronisation Signal (SS)/Physical Broadcast CHannel (PBCH) block.

In one embodiment, the M reference signals comprise a CSI-RS.

In one embodiment, the M reference signals comprise a periodic CSI-RS.

In one embodiment, the M reference signals comprise an SS/PBCH block.

In one embodiment, any of the M reference signals comprises a CSI-RS or an SS/PBCH block.

In one embodiment, the M reference signals are respectively identified by M reference signal identifiers, the M reference signal identifiers including at least one of NZP-CSI-RS-ResourceId or SSB-Index.

In one subembodiment, the M reference signal identifiers are mutually different.

In one embodiment, the M reference signals belong to a same Carrier.

In one embodiment, the M reference signals belong to a same Bandwidth Part (BWP).

In one embodiment, the M reference signals belong to a same serving cell.

In one embodiment, there are two reference signals belonging to different cells among the M reference signals.

In one embodiment, there are two reference signals belonging to cells with different Physical Cell Identities (PCIs) among the M reference signals.

In one embodiment, the reference signal comprises a reference signal resource.

In one embodiment, the reference signal comprises a reference signal port.

In one embodiment, the reference signal comprises an antenna port.

In one embodiment, the M reference signals and the first resource subset belong to a same serving cell.

In one embodiment, the M reference signals and the first resource subset belong to a same BWP.

In one embodiment, the first signaling belongs to a Primary Cell (PCell) or a Primary SCG cell (PSCell).

In one embodiment, the first signal belongs to a Primary Cell (PCell) or a Primary SCG cell (PSCell).

In one embodiment, the first signal belongs to a Secondary Cell (SCell).

In one embodiment, the first signaling and the first resource subset belong to a same serving cell.

In one embodiment, the first signaling and the first resource subset belong to a same BWP.

In one embodiment, the channel carrying the first signal includes: a physical layer channel carrying the first signal.

In one embodiment, the channel carrying the first signal includes only a physical layer channel carrying the first signal.

In one embodiment, the sentence that whether the target reference signal is the first reference signal is related to a type/types of the channel/channels carrying the first signal includes a meaning that whether the target reference signal is the first reference signal is related to the type(s) of (a) physical layer channel(s) carrying the first signal.

In one embodiment, the first type is PRACH.

In one embodiment, the first type is PUSCH.

In one embodiment, the first type is PUCCH.

In one embodiment, a physical layer channel carrying the first signal includes a PRACH or a PUSCH.

In one embodiment, a physical layer channel carrying the first signal includes at least the former of a PRACH and a PUSCH, or at least the former of a PUSCH or a PUCCH.

In one embodiment, the type of the channel carrying the first signal includes PRACH or PUSCH.

In one embodiment, the type of the channel carrying the first signal includes at least the former of PRACH and PUSCH, or at least the former of PUSCH or PUCCH.

In one embodiment, the type of the channel carrying the first signal includes: a type of each physical layer channel carrying the first signal.

In one embodiment, the first signal is carried by a physical layer channel.

In one embodiment, the first signal is carried by multiple physical layer channels.

In one embodiment, the first type is PRACH: when and only when a physical layer channel carrying the first signal includes a PRACH, the type of the channel carrying the first signal includes the first type.

In one embodiment, if the type of the channel carrying the first signal includes the first type, the target reference signal is the first reference signal: if the type of the channel carrying the first signal does not include the first type, whether the target reference signal is the first reference signal is related to the first reference signal.

In one embodiment, when the target reference signal is not the first reference signal, the target reference signal is unrelated to the first signal.

In one embodiment, when the target reference signal is not the first reference signal, the target reference signal is a second reference signal: the second reference signal is unrelated to the first signal.

In one embodiment, the first reference signal and the second reference signal are determined in different ways.

In one embodiment, the meaning of the sentence of whether the target reference signal is the first reference signal includes whether the first reference signal is used to update spatial parameters for the monitoring in the first resource subset.

In one embodiment, when the target reference signal is the first reference signal, the first reference signal is used to update spatial parameters for the monitoring in the first resource subset; when the target reference signal is not the first reference signal, the first reference signal is not used to update spatial parameters for the monitoring in the first resource subset.

In one embodiment, the meaning of the sentence of whether the target reference signal is the first reference signal includes whether the first reference signal is used to determine spatial parameters for the monitoring in the first resource subset.

In one embodiment, when the target reference signal is the first reference signal, the first reference signal is used to determine spatial parameters for the monitoring in the first resource subset; when the target reference signal is not the first reference signal, the first reference signal is not used to determine spatial parameters for the monitoring in the first resource subset.

In one embodiment, as a response to the action of transmitting a first signal, the first node receives the first signaling.

In one embodiment, along with the action of transmitting a first signal, the first node receives the first signaling.

In one embodiment, when the target reference signal is the first reference signal, as a response to the action of receiving a first signaling, the first node assumes the same spatial parameters as those of the target reference signal after the first time for the monitoring of the first-type channel in the first resource subset.

### Embodiment 2

Embodiment 2 illustrates a schematic diagram of a network architecture according to one embodiment of the present application, as shown in FIG. 2.

FIG. 2 illustrates a network architecture 200 of Long-Term Evolution (LTE). Long-Term Evolution Advanced (LTE-A) as well as future 5G systems. The network architecture 200 of LTE. LTE-A and future 5G systems is called an Evolved Packet System (EPS) 200. The 5G NR or LTE network architecture 200 can be called a 5G System/Evolved Packet System (5GS/EPS) 200 or other suitable terminology. The 5GS/EPS 200 may comprise one or more UEs 201, a UE241 in sidelink communications with UE(s) 201, an NG-RAN 202, a 5G Core Network/Evolved Packet Core (5GC/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN202 comprises a New Radio (NR) node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones. Session Initiation Protocol (SIP) phones, laptop computers. Personal Digital Assistant (PDA). Satellite Radios. Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an SI/NG interface. The 5GC/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet. IP Multimedia Subsystem (IMS) and Packet Switching (PS) services.

In one embodiment, the first node in the present application includes the UE 201.

In one embodiment, the second node in the present application includes the gNB203.

In one embodiment, a radio link between the UE201 and the gNB203 is a cellular link.

In one embodiment, the transmitter of the first signal includes the UE201.

In one embodiment, the receiver of the first signal includes the gNB203.

In one embodiment, the transmitter of the first signaling includes the gNB203.

In one embodiment, the receiver of the first signaling includes the UE201.

In one embodiment, the transmitter of the first-type channel includes the gNB203.

In one embodiment, the receiver of the first-type channel includes the UE201.

In one embodiment, the UE 201 supports beam failure detection and beam failure recovery per TRP.

### Embodiment 3

Embodiment 3 illustrates a schematic diagram of an example of a radio protocol architecture of a user plane and a control plane according to the present application, as shown in FIG. 3.

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are L1. L2 and L3. The layer 1 (L1) is the lowest layer which performs signal processing functions of various PHY layers. The L1 is called PHY 301 in the present application. The layer 2 (L2) 305 is above the PHY 301, and is in charge of the link between a first communication node and a second communication node as well as between two UEs. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second communication nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300. The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signal is generated by the PHY 301, or the PHY 351.

In one embodiment, the first signal is generated by the MAC sublayer 302, or the MAC sublayer 352.

In one embodiment, the first signaling is generated by the PHY 301, or the PHY 351.

In one embodiment, the first signaling is generated by the MAC sublayer 302, or the MAC sublayer 352.

In one embodiment, the first-type channel is generated by the PHY 301, or the PHY 351.

In one embodiment, the M reference signals are generated by the PHY 301, or the PHY 351.

In one embodiment, the first reference signal subgroup and the second reference signal subgroup are generated by the PHY 301, or the PHY 351.

In one embodiment, the first information block is generated by the RRC sublayer 306.

### Embodiment 4

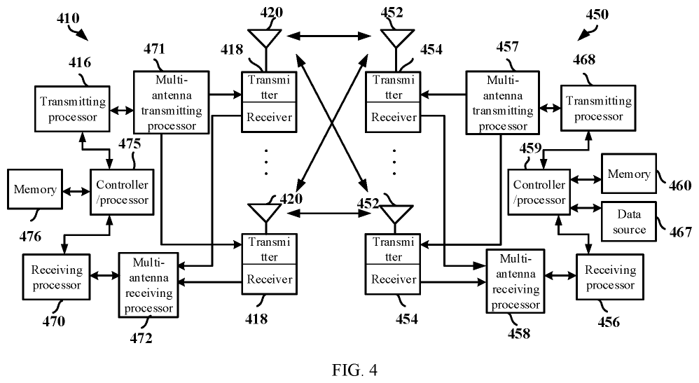

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the constellation mapping corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream into a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2 layer. Or various control signals can be provided to the L3 for processing. The controller/processor 459 is also in charge of using ACK and/or NACK protocols for error detection as a way to support HARQ operation.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 layer functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with a memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocols to support HARQ operation.

In one embodiment, the second communication device 450 comprises at least one processor and at least one memory. The at least one memory comprises computer program codes: the at least one memory and the computer program codes are configured to be used in collaboration with the at least one processor. The second communication device 450 at least: transmits the first signal; and receives the first signaling: and monitors a first-type channel in the first resource subset with same spatial parameters as those of the target reference signal after the first time.

In one embodiment, the second communication device 450 comprises a memory that stores computer readable instruction program, the computer readable instruction program generates actions when executed by at least one processor, which include: transmitting the first signal; and receiving the first signaling: and monitoring a first-type channel in the first resource subset with same spatial parameters as those of the target reference signal after the first time.

In one embodiment, the first communication device 410 comprises at least one processor and at least one memory. The at least one memory comprises computer program codes: the at least one memory and the computer program codes are configured to be used in collaboration with the at least one processor. The first communication device 410 at least: receives the first signal; and transmits the first signaling: and transmits the first-type channel in the first resource subset after the first time.

In one embodiment, the first communication device 410 comprises a memory that stores computer readable instruction program, the computer readable instruction program generates actions when executed by at least one processor, which include: receiving the first signal; and transmitting the first signaling: and transmitting the first-type channel in the first resource subset after the first time.

In one embodiment, the first node in the present application comprises the second communication device 450.

In one embodiment, the second node in the present application comprises the first communication device 410.

In one embodiment, at least one of the antenna 420, the receiver 418, the receiving processor 470, the multi-antenna receiving processor 472, the controller/processor 475 or the memory 476 is used to receive the first signal: at least one of the antenna 452, the transmitter 454, the transmitting processor 468, the multi-antenna transmitting processor 457, the controller/processor 459, the memory 460 or the data source 467 is used to transmit the first signal.

In one embodiment, at least one of the antenna 452, the receiver 454, the receiving processor 456, the multi-antenna receiving processor 458, the controller/processor 459, the memory 460 or the data source 467 is used to receive the first signaling: at least one of the antenna 420, the transmitter 418, the transmitting processor 416, the multi-antenna transmitting processor 471, the controller/processor 475 or the memory 476 is used to transmit the first signaling.

In one embodiment, at least one of the antenna 452, the receiver 454, the receiving processor 456, the multi-antenna receiving processor 458, the controller/processor 459, the memory 460 or the data source 467 is used to monitor the first-type channel in the first resource subset with the same spatial parameters as those of the target reference signal after the first time: at least one of the antenna 420, the transmitter 418, the transmitting processor 416, the multi-antenna transmitting processor 471, the controller/processor 475 or the memory 476 is used to transmit the first-type channel in the first resource subset after the first time.

In one embodiment, at least one of the antenna 452, the receiver 454, the receiving processor 456, the multi-antenna receiving processor 458, the controller/processor 459, the memory 460 or the data source 467 is used to receive the M reference signals: at least one of the antenna 420, the transmitter 418, the transmitting processor 416, the multi-antenna transmitting processor 471, the controller/processor 475 or the memory 476 is used to transmit the M reference signals.

In one embodiment, at least one of the antenna 452, the receiver 454, the receiving processor 456, the multi-antenna receiving processor 458, the controller/processor 459, the memory 460 or the data source 467 is used to receive the first reference signal subgroup and the second reference signal subgroup; at least one of the antenna 420, the transmitter 418, the transmitting processor 416, the multi-antenna transmitting processor 471, the controller/processor 475 or the memory 476 is used to transmit the first reference signal subgroup and the second reference signal subgroup.

In one embodiment, at least one of the antenna 452, the receiver 454, the receiving processor 456, the multi-antenna receiving processor 458, the controller/processor 459, the memory 460 or the data source 467 is used to monitor the first-type channel in the target resource set group with the same spatial parameters as those of the first reference signal after the first time: at least one of the antenna 420, the transmitter 418, the transmitting processor 416, the multi-antenna transmitting processor 471, the controller/processor 475 or the memory 476 is used to transmit the first-type channel in the target resource set group after the first time.

In one embodiment, at least one of the antenna 452, the receiver 454, the receiving processor 456, the multi-antenna receiving processor 458, the controller/processor 459, the memory 460 or the data source 467 is used to receive the first information block: at least one of the antenna 420, the transmitter 418, the transmitting processor 416, the multi-antenna transmitting processor 471, the controller/processor 475 or the memory 476 is used to transmit the first information block.

### Embodiment 5

Embodiment 5 illustrates a flowchart of wireless transmission according to one embodiment of the present application, as shown in FIG. 5. In FIG. 5, a second node U1 and a first node U2 are communication nodes that transmit via an air interface. In FIG. 5, steps marked by boxes F51 to F57 are optional, respectively.

The second node U1 transmits a first information block in step S5101: transmits a first reference signal subgroup and a second reference signal subgroup in step S5102: and transmits M reference signals in step S5103; transmits a first-type channel in a second resource subset before first time in step S5104; and receives a first signal in step S511: transmits a first signaling in step S512: and transmits the first-type channel in a first resource subset after the first time in step S513: and in step S5105, transmits a second signaling in the first resource subset after the first time: in step S5106, transmits the first-type channel in a target resource set group after the first time: and in step S5107, transmits a third signaling after the first time.

The first node U2 receives a first information block in step S5201: receives a first reference signal subgroup and a second reference signal subgroup in step S5202: and receives M reference signals in step S5203: monitors a first-type channel in a second resource subset with same spatial parameters as those of a second reference signal before first time in step S5204: and transmits a first signal in step S521: receives a first signaling in step S522: and monitors the first-type channel in a first resource subset with same spatial parameters as those of a target reference signal after the first time in step S523: and in step S5205, receives a second signaling in the first resource subset after the first time: in step S5206, monitors the first-type channel in a target resource set group with same spatial parameters as those of a first reference signal after the first time: and in step S5207, receives a third signaling after the first time.

In Embodiment 5, the first signal is used to indicate the first reference signal: the first signaling is used by the first node U2 to determine the first time: the first reference signal is one of the M reference signals. M being a positive integer greater than 1; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

In one embodiment, the first node U2 is the first node in the present application.

In one embodiment, the second node U1 is the second node in the present application.

In one embodiment, an air interface between the second node U1 and the first node U2 includes a radio interface between a base station and a UE.

In one embodiment, an air interface between the second node U1 and the first node U2 includes a radio interface between a UE and another UE.

In one embodiment, the second node U1 is a maintenance base station for a serving cell of the first node U2.

In one embodiment, the second node transmits the first-type channel in the first resource subset with same spatial parameters as those of the target reference signal after the first time.

In one embodiment. DeModulation Reference Signals (DMRS) of the first-type channel being transmitted in the first resource subset after the first time and the target reference signal are QCL.

In one subembodiment. DMRS of the first-type channel being transmitted in the first resource subset after the first time and the target reference signal are QCL with QCL-TypeD.

In one embodiment, the second node transmits the target reference signal and transmits the first-type channel in the first resource subset using a same spatial domain filter.

In one embodiment, the first signal is transmitted on a PRACH.

In one embodiment, the first signal is transmitted on an uplink physical layer data channel (i.e., an uplink channel capable of bearing physical layer data).

In one embodiment, the first signal is transmitted on a PUSCH.

In one embodiment, the first signal is transmitted on a PUCCH.

In one embodiment, the first signal is transmitted on a PRACH and a PUSCH.

In one embodiment, the first signal is transmitted on a PUSCH and a PUCCH.

In one embodiment, the first signaling is transmitted in a downlink physical layer control channel (i.e., a downlink channel only capable of bearing physical layer signaling).

In one embodiment, the first signaling is transmitted on a PDCCH.

In one embodiment, the steps marked by the box F51 in FIG. 5 exist: the first information block is used by the first node U2 to determine the M reference signals.

In one embodiment, the first information block is transmitted in a PDSCH.

In one embodiment, the steps marked by the box F52 in FIG. 5 exist: a measurement of the first reference signal subgroup is used by the first node U2 to determine a first received quality subgroup, while a measurement of the second reference signal subgroup is used by the first node U2 to determine a second received quality subgroup, each of the first reference signal subgroup and the second reference signal subgroup respectively comprising at least one reference signal, and each of the first received quality subgroup and the second received quality subgroup respectively comprising at least one second-type received quality: where the first received quality subgroup and the second received quality subgroup are used by the first node U2 to determine whether a second condition set is satisfied, and whether the second condition set is satisfied is used by the first node U2 to determine whether the first signal is to be transmitted.

In one embodiment, the steps marked by the box F53 in FIG. 5 exist: measurements of the M reference signals are respectively used by the first node U2 to determine M first-type received qualities; herein, the M first-type received qualities are used by the first node U2 to determine the first reference signal.

In one embodiment, the steps marked by the box F54 in FIG. 5 exist: the method in the first node for wireless communications includes: monitoring the first-type channel in a second resource subset before the first time; herein, before the first time, the same spatial parameters as those of a second reference signal are assumed for the monitoring of the first-type channel in the second resource subset.

In one embodiment, the second resource subset comprises a CORESET.

In one embodiment, the second resource subset comprises a search space set.

In one embodiment, the second resource subset comprises at least one PDCCH candidate.

In one embodiment, the second resource subset and the first resource subset are both CORESETs with index 0.

In one embodiment, the second resource subset comprises part or all of PDCCH candidates in a CORESET with index 0 before the first time.

In one embodiment, an index of a CORESET to which the second resource subset belongs is equal to 0.

In one embodiment, an index of a search space set to which the second resource subset belongs is equal to 0.

In one embodiment, an end time of the second resource subset is no later than the first time.

In one embodiment, the second reference signal is used to determine time-domain resources occupied by the second resource subset.

In one embodiment, the first resource subset and the second resource subset belong to a same CORESET.

In one embodiment, the first resource subset and the second resource subset belong to different CORESETs.

In one embodiment, the first resource subset and the second resource subset belong to a same search space set.

In one embodiment, the first resource subset and the second resource subset belong to different search space sets.

In one embodiment, the steps marked by the box F55 in FIG. 5 exist: the method in the first node for wireless communications includes: receiving a second signaling in the first resource subset after the first time; herein the second signaling comprises a second field, the value of the second field in the second signaling being related to a number of first-type signalings transmitted in a target resource set group, the target resource set group being a first resource set group or a second resource set group; the value of the second field in the second signaling is unrelated to a number of first-type signalings transmitted in a resource set group of the first resource set group and the second resource set group other than the target resource set group; when the target reference signal is the first reference signal, the first reference signal is used to determine the target resource set group.

In one embodiment, the second signaling is transmitted in a first-type channel in the first resource subset.

In one embodiment. DMRS of the second signaling and the target reference signal are QCL.

In one embodiment. DMRS of the second signaling and the target reference signal are QCL with QCL-TypeD.

In one embodiment, the first-type signaling includes DCI for downlink grant. DCI for Semi-Persistent Scheduling (SPS) release, and DCI for indicating dormancy of a Secondary Cell (SCell).

In one embodiment, the first-type signaling is transmitted on a PDCCH.

In one embodiment, the second field in the second signaling denotes a number of serving cell-monitoring occasion pairs in a third resource set group that include the first-type signaling having been accumulated up to the current serving cell and the current monitoring occasion, firstly in an increasing order of the start time of PDSCH receptions for the same serving cell-monitoring occasion pairs, and then in an increasing order of the index of serving cells and then an increasing order of the index of monitoring occasions, if the first node is configured to support multiple PDSCH receptions in being scheduled from a same monitoring occasion in a serving cell.

In one embodiment, the second field in the second signaling denotes a total number of serving cell-monitoring occasion pairs in a third resource set group that include the first-type signaling having been accumulated up to the current monitoring occasion.

In one embodiment, the third resource set group is the target resource set group.

In one embodiment, the third resource set group comprises the target resource set group and the first resource subset.

In one embodiment, the third resource set group comprises the target resource set group and CORESETs with index 0.

In one embodiment, the third resource set group consists of the target resource set group and the first resource subset.

In one embodiment, a value of the second field in the second signaling is unrelated to a number of serving cell-monitoring occasion pairs in one resource set group of the first resource set group and the second resource set group other than the target resource set group that include the first-type signaling having been accumulated up to the current serving cell and the current monitoring occasion.

In one embodiment, a value of the second field in the second signaling is unrelated to a total number of serving cell-monitoring occasion pairs in one resource set group of the first resource set group and the second resource set group other than the target resource set group that include the first-type signaling having been accumulated up to the current monitoring occasion.

In one embodiment, when the target reference signal is the first reference signal, whether the first reference signal belongs to the first reference signal subset or the second reference signal subset is used to determine whether the target resource set group is the first resource set group or the second resource set group.

In one embodiment, the first resource set group corresponds to the first reference signal subset, while the second resource set group corresponds to the second reference signal subset; when the target reference signal is the first reference signal and the first reference signal belongs to the first reference signal subset, the target resource set group is the first resource set group; when the target reference signal is the first reference signal and the first reference signal belongs to the second reference signal subset, the target resource set group is the second resource set group.

In one embodiment, the steps marked by the box F56 in FIG. 5 exist: the target resource set group is a first resource set group or a second resource set group; the first reference signal is used by the first node to determine the target resource set group.

In one embodiment, the steps marked by the box F57 in FIG. 5 exist: the method in the first node for wireless communications includes: receiving a third signaling after the first time; herein the third signaling comprises a MAC CE or a DCI; the third signaling comprises a third field and a fourth field, the third field in the third signaling indicating a given CORESET, and the fourth field in the third signaling indicating an index of a CORESET pool corresponding to the given CORESET.

In one embodiment, an index of the CORESET pool refers to coresetPoolIndex.

In one embodiment, the third field in the third signaling indicates an index of the given CORESET.

In one embodiment, an index of a CORESET indicated by the third field is unequal to 0.

In one embodiment, the third signaling is a MAC CE.

In one embodiment, the third signaling is a DCI.

In one embodiment, the third signaling is used for updating an index of a CORESET pool corresponding to the given CORESET.

In one embodiment, the third signaling is transmitted on a PDSCH.

In one embodiment, the third signaling is transmitted on a PDCCH.

### Embodiment 6

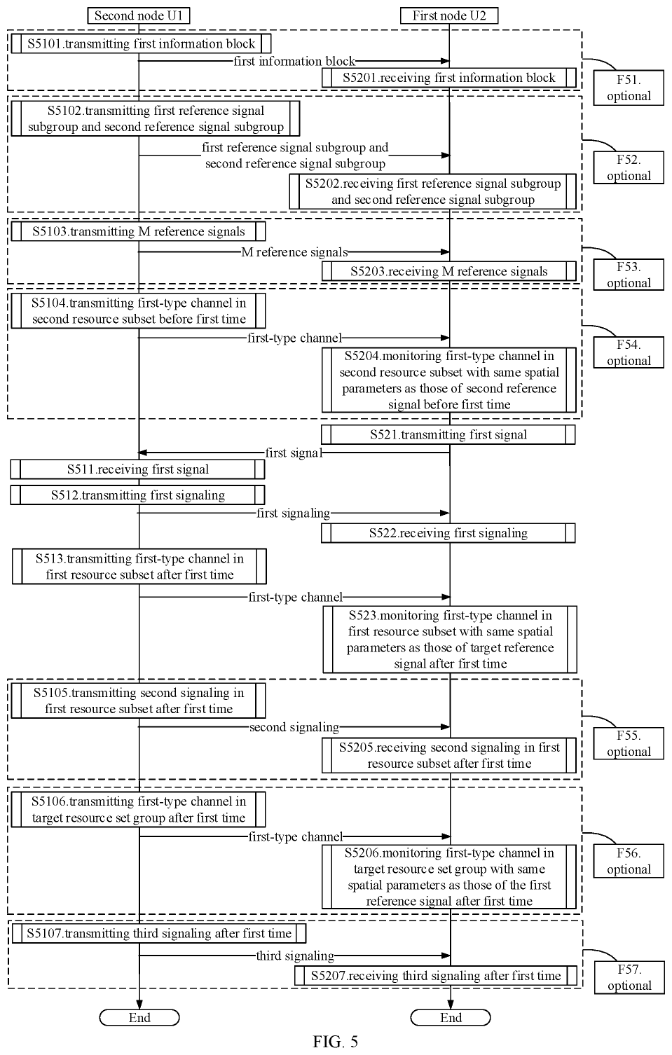

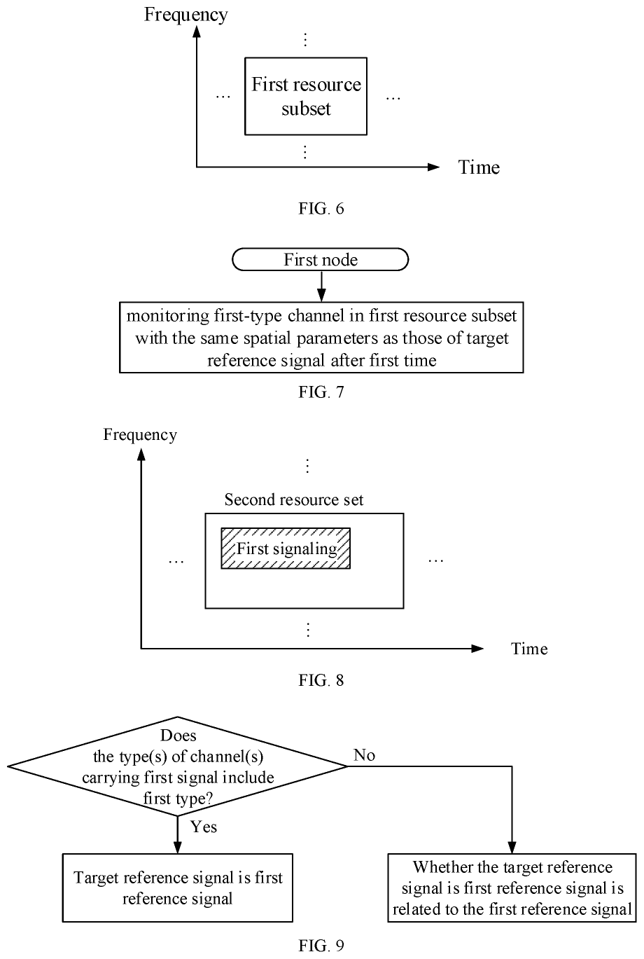

Embodiment 6 illustrates a schematic diagram of a first resource subset according to one embodiment of the present application, as shown in FIG. 6.

In one embodiment, the first resource subset occupies at least one symbol in time domain.

In one embodiment, the first resource subset occupies at least one Physical Resource Block (PRB) in frequency domain.

In one embodiment, the first resource subset comprises a CORESET.

In one embodiment, the first resource subset is a CORESET.

In one embodiment, the first resource subset comprises a search space set.

In one embodiment, the first resource subset is a search space set.

In one embodiment, the first resource subset comprises at least one PDCCH Candidate.

In one embodiment, the first resource subset comprises all or partial PDCCH candidates in a search space set.

In one embodiment, the first resource subset comprises all or partial PDCCH candidates and/or all or partial PDCCH monitoring occasions in a search space set after the first time.

In one embodiment, the first resource subset comprises a CORESET with index 0.

In one embodiment, the first resource subset is a CORESET with index 0.

In one embodiment, the first resource subset comprises part of a CORESET with index 0 after the first time.

In one embodiment, the first resource subset comprises all or partial PDCCH candidates and/or all or partial PDCCH monitoring occasions in a CORESET with index 0 after the first time.

In one embodiment, an index of a CORESET to which the first resource subset belongs is equal to 0.

In one embodiment, an index of a CORESET to which the first resource subset belongs is unequal to 0.

In one embodiment, an index of a search space set to which the first resource subset belongs is equal to 0.

In one embodiment, the first resource subset comprises a Type0-PDCCH Common Search Space (CSS).

In one embodiment, the first resource subset comprises all or partial PDCCH candidates and/or all or partial PDCCH monitoring occasions in a Type0-PDCCH CSS after the first time.

In one embodiment, the first resource subset comprises part of a Type0-PDCCH CSS after the first time.

In one embodiment, a search space set to which the first resource subset belongs includes a CSS set.

In one embodiment, a search space set to which the first resource subset belongs includes a UE-specific search space (USS) set.

In one embodiment, a start time of the first resource subset is no earlier than the first time.

In one embodiment, a CORESET to which the first resource subset belongs is configured by system information.

In one embodiment, the first resource subset is configured by system information.

In one embodiment, the first resource subset occurs multiple times in time domain.

In one embodiment, the first resource subset occurs periodically in time domain.

In one embodiment, the first resource subset occurs only once in time domain.

In one embodiment, time-domain resources occupied by the first resource subset are related to the target reference signal.

In one embodiment, the target reference signal is used to determine time-domain resources occupied by the first resource subset.

### Embodiment 7

Embodiment 7 illustrates a schematic diagram of a first node monitoring a first-type channel in a first resource subset with the same spatial parameters as those of a target reference signal after first time according to one embodiment of the present application: as shown in FIG. 7.

In one embodiment, the spatial parameters comprise a TCI state.

In one embodiment, the spatial parameters comprise a Quasi-Co-Located (QCL) assumption.

In one embodiment, the spatial parameters comprise QCL parameters.

In one embodiment, the spatial parameters comprise antenna port QCL parameters.

In one embodiment, the spatial parameters comprise a Spatial Relation.

In one embodiment, the spatial parameters comprise a spatial domain filter.

In one embodiment, the spatial domain filter comprises a spatial domain transmission filter.

In one embodiment, the spatial domain filter comprises a spatial domain receive filter.

In one embodiment, the spatial parameters comprise a Spatial Tx parameter.

In one embodiment, the spatial parameters comprise a Spatial Rx parameter.

In one embodiment, the spatial parameters comprise large-scale properties.

In one embodiment, the large-scale properties include one or more of a delay spread, a Doppler spread, a Doppler shift, or an average delay or a Spatial Rx parameter.

In one embodiment, the sentence of monitoring a first-type channel in a first resource subset with same spatial parameters as those of a target reference signal means that: for the monitoring of the first-type channel in the first resource subset, the first node assumes the same spatial parameters as those of the target reference signal.

In one embodiment, the sentence of monitoring a first-type channel in a first resource subset with same spatial parameters as those of a target reference signal means that: DMRS of the first-type channel being transmitted in the first resource subset and the target reference signal are QCL.

In one subembodiment. DMRS of the first-type channel being transmitted in the first resource subset and the target reference signal are QCL with QCL-TypeD.

In one embodiment, the first node can infer large-scale properties of a channel over which the target reference signal is conveyed from large-scale properties of a channel over which the DMRS of the first-type channel being transmitted in the first resource subset is conveyed.

In one embodiment, the first node can infer spatial Rx parameters of a channel over which the target reference signal is conveyed from spatial Rx parameters of a channel over which the DMRS of the first-type channel being transmitted in the first resource subset is conveyed.

In one embodiment, the first node receives the target reference signal and monitors the first-type channel in the first resource subset using a same spatial domain filter.

### Embodiment 8

Embodiment 8 illustrates a schematic diagram of time-frequency resources occupied by a first signaling belonging to a second resource set according to one embodiment of the present application: as shown in FIG. 8.

In one embodiment, the first signaling is transmitted in a PDCCH in a second resource set; as a response to the action of transmitting the first signal, the first node monitors the PDCCH in the second resource set.

In one embodiment, the first signaling is transmitted in a PDCCH in a second resource set; when the type/types of the channel/channels carrying the first signal includes/include the first type, as a response to the action of transmitting the first signal, the first node monitors the PDCCH in the second resource set.

In one embodiment, the first signaling is transmitted in a PDCCH in a second resource set; along with the action of transmitting the first signal, the first node monitors the PDCCH in the second resource set.

In one embodiment, the first signaling is transmitted in a PDCCH in a second resource set; when the type/types of the channel/channels carrying the first signal includes/include the first type, along with the action of transmitting the first signal, the first node monitors the PDCCH in the second resource set.

In one embodiment, the second resource set comprises a search space set.

In one embodiment, the second resource set is a search space set.

In one embodiment, the second resource set comprises a CORESET.

In one embodiment, the second resource set comprises at least one PDCCH Candidate.

In one embodiment, the second resource set comprises a search space set identified by a recovery SearchSpaceId.

In one embodiment, the second resource set is a search space set identified by a recovery SearchSpaceId.

In one embodiment, an index of the second resource set is configured by a higher-layer parameter, where a name of the higher-layer parameter includes “recovery SearchSpace”.

In one embodiment, the first signal belongs to time unit n in time domain: along with the action of transmitting the first signal, the first node monitors the PDCCH in the second resource set starting from time unit (n+second interval).

In one embodiment, the first signal belongs to time unit n in time domain: when the type/types of the channel/channels carrying the first signal includes/include the first type, along with the action of transmitting the first signal, the first node monitors the PDCCH in the second resource set starting from time unit (n+second interval).

In one embodiment, the time unit is a slot.

In one embodiment, the time unit is a sub-slot.

In one embodiment, the time unit is a sub-frame.

In one embodiment, the time unit is a symbol.

In one embodiment, the time unit consists of a positive integer number of consecutive symbols.

In one embodiment, the second interval is a non-negative integer.

In one embodiment, the second interval is pre-defined.

In one embodiment, the second interval is not in need of configuration.

In one embodiment, the second interval is fixed.

In one embodiment, the second interval is fixed to 4.

In one embodiment, the first node monitors the PDCCH in the second resource set to detect a DCI format of which CRC is scrambled by a C-RNTI or an MCS-C-RNTI.

In one embodiment, the sentence monitoring the PDCCH is similar in meaning to the sentence monitoring a first-type channel, except that the first-type channel is replaced with a PDCCH.

### Embodiment 9

Embodiment 9 illustrates a schematic diagram of whether a target reference signal is a first reference signal relating to the type(s) of channel(s) carrying a first signal according to one embodiment of the present application: as shown in FIG. 9. In Embodiment 9, when the type/types of the channel carrying the first signal includes/include the first type, the target reference signal is the first reference signal; when the type/types of the channel/channels carrying the first signal does/do not include the first type, whether the target reference signal is the first reference signal is related to the first reference signal.

In one embodiment, each of the first reference signal subset and the second reference signal subset respectively comprises at least one reference signal of the M reference signals: any reference signal in the first reference signal subset is one of the M reference signals, and any reference signal in the second reference signal subset is one of the M reference signals.

In one embodiment, there does not exist a reference signal among the M reference signals that belongs to both the first reference signal subset and the second reference signal subset.

In one embodiment, any reference signal among the M reference signals belongs to the first reference signal subset or the second reference signal subset.

In one embodiment, there is a reference signal among the M reference signals that belongs to neither the first reference signal subset nor the second reference signal subset simultaneously.

In one embodiment, the first reference signal subset and the second reference signal subset are two RS sets for candidate beam selection, respectively.

In one embodiment, the first reference signal subset and the second reference signal subset respectively belong to different TRPs.

In one embodiment, each of the first reference signal subset and the second reference signal subset respectively corresponds to a second-type index: the second-type index corresponding to the first reference signal subset is unequal to the second-type index corresponding to the second reference signal subset; the second-type index is a non-negative integer.

In one embodiment, any reference signal in the first reference signal subset and the second reference signal subset corresponds to a second-type index: the second-type indexes corresponding to any two reference signals in the first reference signal subset are equal, and the second-type indexes corresponding to any two reference signals in the second reference signal subset are equal: the second-type index corresponding to any reference signal in the first reference signal subset is unequal to the second-type index corresponding to any reference signal in the second reference signal subset; the second-type index is a non-negative integer.

In one embodiment, a higher layer signaling is used to determine the second-type index.

In one embodiment, the second-type index is configured by a higher-layer signaling.

In one embodiment, the second-type index is used for identifying a group of reference signals.

In one embodiment, the second-type index is used for identifying a TRP.

In one embodiment, the second-type index is used for identifying a group of TCI states.

In one embodiment, when the type/types of the channel/channels carrying the first signal does/do not include the first type, whether the first reference signal belongs to the first reference signal subset or the second reference signal subset is used to determine whether the target reference signal is the first reference signal.

### Embodiment 10

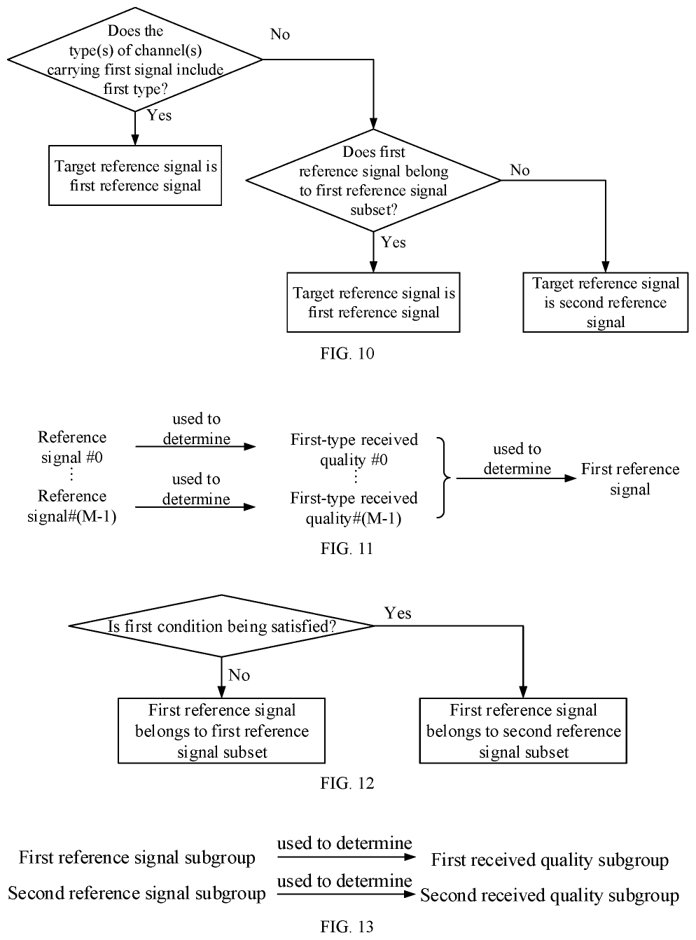

Embodiment 10 illustrates a schematic diagram of whether a target reference signal is a first reference signal relating to the type(s) of channel(s) carrying a first signal according to one embodiment of the present application: as shown in FIG. 10. When the type/types of the channel carrying the first signal includes/include the first type, the target reference signal is the first reference signal; when the type/types of the channel/channels carrying the first signal does/do not include the first type and the first reference signal belongs to the first reference signal subset, the target reference signal is the first reference signal; when the type/types of the channel/channels carrying the first signal does/do not include the first type and the first reference signal belongs to the second reference signal subset, the target reference signal is a second reference signal.

In one embodiment, the second reference signal is not the first reference signal.

In one embodiment, the second reference signal and the first reference signal are not quasi co-located (non-QCL).

In one embodiment, the second reference signal and the first reference signal are not QCL with QCL-TypeD.

In one embodiment, the second reference signal is unrelated to the first reference signal.

In one embodiment, the second reference signal is unrelated to the first signal.

In one embodiment, the second reference signal and the first reference signal correspond to different reference signal identifiers.

In one embodiment, the second reference signal is configured by RRC signaling.

In one embodiment, the second reference signal is indicated by a MAC CE.

In one embodiment, the second reference signal comprises a CSI-RS.

In one embodiment, the second reference signal comprises an SSB.

In one embodiment, the second reference signal is a periodic reference signal.

In one embodiment, when the type/types of the channel carrying the first signal does/do not include the first type and the first reference signal belongs to the second reference signal subset, the first node assumes the same spatial parameters, before and after the first time, for the monitoring of the first-type channel in a CORESET to which the first resource subset belongs.

In one embodiment, when the type/types of the channel/channels carrying the first signal includes/include the first type, or when the type/types of the channel/channels carrying the first signal does/do not include the first type and the first reference signal belongs to the first reference signal subset, the first node assumes the same spatial parameters as those of the first reference signal after the first time for the monitoring of the first-type channel in the first resource subset.

In one subembodiment, as a response to the action of receiving a first signaling, the first node assumes the same spatial parameters as those of the first reference signal after the first time for the monitoring of the first-type channel in the first resource subset.

### Embodiment 11

Embodiment 11 illustrates a schematic diagram of M reference signals and M first-type received qualities according to one embodiment of the present application: as shown in FIG. 11. In Embodiment 11, measurements of the M reference signals are respectively used to determine the M first-type received qualities; herein, the M first-type received qualities are used to determine the first reference signal. In FIG. 11, the M reference signals are denoted as reference signal #0 . . . , and reference signal #(M-1), respectively: the M first-type received qualities are denoted as first-type received quality #0 . . . first-type received quality #(M-1), respectively.

In one embodiment, any first-type received quality among the M first-type received qualities is a Reference Signal Received Power (RSRP).

In one embodiment, any first-type received quality among the M first-type received qualities is a L1-RSRP.

In one embodiment, any first-type received quality among the M first-type received qualities is a Signal-to-noise and interference ratio (SINR).

In one embodiment, any first-type received quality among the M first-type received qualities is a L1-SINR.

In one embodiment, any first-type received quality among the M first-type received qualities is a BLock Error Rate (BLER).

In one embodiment, a given reference signal is a reference signal among the M reference signals.

In one subembodiment, an RSRP or L1-RSRP of the given reference signal is used to determine a first-type received quality among the M first-type received qualities that corresponds to the given reference signal.

In one subembodiment, a first-type received quality among the M first-type received qualities that corresponds to the given reference signal is equal to an RSRP or L1-RSRP of the given reference signal.

In one subembodiment, a first-type received quality among the M first-type received qualities that corresponds to the given reference signal is equal to a L1-RSRP obtained by scaling a received power of the given reference signal according to a value indicated by a first higher-layer parameter, a name of the first higher-layer parameter including “powerControlOffsetSS”.

In one subembodiment, a SINR or L1-SINR of the given reference signal is used to determine a first-type received quality among the M first-type received qualities that corresponds to the given reference signal.

In one subembodiment, a first-type received quality among the M first-type received qualities that corresponds to the given reference signal is equal to a SINR or L1-SINR of the given reference signal.

In one subembodiment, a first-type received quality among the M first-type received qualities that corresponds to the given reference signal is obtained by looking up the table of RSRP. L1-RSRP. SINR or L1-SINR for the given reference signal.

In one subembodiment, the given reference signal is any reference signal among the M reference signals.

In one embodiment, a first-type received quality corresponding to the first reference signal among the M first-type received qualities is better than a first threshold.

In one embodiment, a first-type received quality corresponding to the first reference signal among the M first-type received qualities is better than or equal to a first threshold.

In one embodiment, the first reference signal is one of the M reference signals that corresponds to a first-type received quality better than the first threshold.

In one embodiment, the first reference signal is one of the M reference signals that corresponds to a first-type received quality better than or equal to the first threshold.

In one embodiment, a higher layer of the first node indicates the first reference signal to a physical layer of the first node.

In one embodiment, the first threshold is a real number.

In one embodiment, the first threshold is a non-negative real number.

In one embodiment, the first threshold is a non-negative real number no greater than 1.

In one embodiment, the first threshold is equal to Q_{in_LR}.

In one embodiment, the definition of the Q_{in_LR} can be found in 3GPP TS38.133.

In one embodiment, the first threshold is configured by a higher layer parameter, a name of the higher layer parameter configuring the first threshold includes “rsrp-Threshold”.

In one embodiment, that a first-type received quality is better/worse than a threshold means that the first-type received quality is one of RSRP. L1-RSRP. SINR or L1-SINR, the first-type received quality being greater/smaller than the threshold.

In one embodiment, that a first-type received quality is better/worse than a threshold means that the first-type received quality is BLER, the first-type received quality being smaller/greater than the threshold.

### Embodiment 12

Embodiment 12 illustrates a schematic diagram of a first condition and a first reference signal according to one embodiment of the present application, as shown in FIG. 12. In Embodiment 12, when the first condition is satisfied, the first reference signal belongs to the second reference signal subset; when the first condition is not satisfied, the first reference signal belongs to the first reference signal subset.

In one embodiment, when the first condition is satisfied, the first node selects the first reference signal from the second reference signal subset; when the first condition is not satisfied, the first node selects the first reference signal from the first reference signal subset.

In one embodiment, the first condition comprises that a first-type received quality corresponding to each reference signal in the first reference signal subset is worse than a first threshold.

In one embodiment, the first condition comprises that a first-type received quality corresponding to each reference signal in the first reference signal subset is no better than a first threshold.

In one embodiment, when there exists a reference signal in the first reference signal subset corresponding to a first-type received quality not worse than the first threshold, the first reference signal is a reference signal in the first reference signal subset corresponding to a first-type received quality not worse than the first threshold.

In one embodiment, when there exists a reference signal in the first reference signal subset corresponding to a first-type received quality better than the first threshold, the first reference signal is a reference signal in the first reference signal subset corresponding to a first-type received quality better than the first threshold.

In one embodiment, the first condition comprises that each reference signal in the first reference signal subset corresponds to a first-type received quality worse than a first threshold, and there exists a reference signal in the second reference signal subset that corresponds to a first-type received quality no worse than a third threshold.

In one embodiment, the first condition comprises that each reference signal in the first reference signal subset corresponds to a first-type received quality not better than a first threshold, and there exists a reference signal in the second reference signal subset that corresponds to a first-type received quality better than a third threshold.

In one embodiment, when each reference signal in the first reference signal subset corresponds to a first-type received quality worse than the first threshold, the first reference signal is a reference signal in the second reference signal subset corresponding to a first-type received quality not worse than a third threshold.

In one embodiment, when each reference signal in the first reference signal subset corresponds to a first-type received quality worse than the first threshold, the first reference signal is a reference signal in the second reference signal subset corresponding to a first-type received quality better than a third threshold.

In one embodiment, the first threshold is unequal to the third threshold.

In one embodiment, the third threshold is equal to the first threshold.

In one embodiment, the third threshold is a real number.

In one embodiment, the third threshold is configured by a higher layer parameter, a name of the higher layer parameter configuring the third threshold includes “rsrp-Threshold”.

### Embodiment 13

Embodiment 13 illustrates a schematic diagram of a first reference signal subgroup, a second reference signal subgroup, a first received quality subgroup and a second received quality subgroup according to one embodiment of the present application: as shown in FIG. 13. In Embodiment 13, a measurement of the first reference signal subgroup is used to determine the first received quality subgroup, while a measurement of the second reference signal subgroup is used to determine the second received quality subgroup.

In one embodiment, the first reference signal subgroup comprises a CSI-RS.

In one embodiment, the first reference signal subgroup comprises a SS/PBCH block.

In one embodiment, the second reference signal subgroup comprises a CSI-RS.

In one embodiment, the second reference signal subgroup comprises a SS/PBCH block.

In one embodiment, any reference signal in the first reference signal subgroup and the second reference signal subgroup comprises a periodic reference signal.

In one embodiment, any reference signal in the first reference signal subgroup and the second reference signal subgroup comprises a CSI-RS or an SS/PBCH block.

In one embodiment, the first reference signal subgroup and the second reference signal subgroup are respectively configured by RRC signaling.

In one embodiment, at least one of the first reference signal subgroup or the second reference signal subgroup is configured by a second higher layer parameter, a name of the second higher layer parameter including “failureDetectionResources”.

In one embodiment, any reference signal in the first reference signal subgroup and the second reference signal subgroup is a reference signal configured by the second higher layer parameter to be used for a link recovery procedure.

In one embodiment, the first node determines at least one of the first reference signal subgroup or the second reference signal subgroup based on a TCI state of a CORESET for monitoring PDCCH.

In one embodiment, there exists a reference signal in the first reference signal subgroup and the second reference signal subgroup being earlier in the time domain than one of the M reference signals.

In one embodiment, there exists a reference signal in the first reference signal subgroup and the second reference signal subgroup being later in the time domain than one of the M reference signals.

In one embodiment, the first reference signal subgroup and the second reference signal subgroup belong to a same BWP.

In one embodiment, the first reference signal subgroup and the second reference signal subgroup belong to a same serving cell.

In one embodiment, the first reference signal subgroup and the second reference signal subgroup belong to different cells.

In one embodiment, the first reference signal subgroup and the second reference signal subgroup belong to different TRPs.

In one embodiment, the first reference signal subgroup and the second reference signal subgroup are respectively two different RS sets for Beam Failure Detection (BFD).

In one embodiment, the first reference signal subgroup, the second reference signal subgroup and the M reference signals belong to a same serving cell.

In one embodiment, the first reference signal subgroup, the second reference signal subgroup and the first resource subset belong to a same serving cell.

In one embodiment, each of the first reference signal subgroup and the second reference signal subgroup respectively corresponds to a third-type index: the third-type index corresponding to the first reference signal subgroup is unequal to the third-type index corresponding to the second reference signal subgroup; the third-type index is a non-negative integer.

In one embodiment, a higher layer signaling is used to determine the third-type index.

In one embodiment, the third-type index is configured by a higher-layer signaling.

In one embodiment, the third-type index is used for identifying a group of reference signals.

In one embodiment, the third-type index is used for identifying a TRP.

In one embodiment, the third-type index is used for identifying a group of TCI states.

In one embodiment, the first reference signal subgroup corresponds to the first reference signal subset, while the second reference signal subgroup corresponds to the second reference signal subset.

In one embodiment, the third-type index corresponding to the first reference signal subgroup is equal to the second-type index corresponding to the first reference signal subset; the third-type index corresponding to the second reference signal subgroup is equal to the second-type index corresponding to the second reference signal subset.

In one embodiment, a number of the at least one reference signal comprised in the first reference signal subgroup is equal to a number of the at least one second-type received quality comprised in the first received quality subgroup, and measurement(s) of the at least one reference signal comprised in the first reference signal subgroup is/are respectively used to determine the at least one second-type received quality comprised in the first received quality subgroup; a number of the at least one reference signal comprised in the second reference signal subgroup is equal to a number of the at least one second-type received quality comprised in the second received quality subgroup, and measurement(s) of the at least one reference signal comprised in the second reference signal subgroup is/are respectively used to determine the at least one second-type received quality comprised in the second received quality subgroup.

In one embodiment, the second-type received quality includes an RSRP.

In one embodiment, the second-type received quality includes a L1-RSRP.

In one embodiment, the second-type received quality includes a SINR.

In one embodiment, the second-type received quality includes a L1-SINR.

In one embodiment, the second-type received quality includes a BLER.

In one embodiment, a given reference signal is a reference signal in the first reference signal subgroup or the second reference signal subgroup.

In one subembodiment, an RSRP or a L1-RSRP of the given reference signal is used to determine a second-type received quality corresponding to the given reference signal.

In one subembodiment, a second-type received quality that corresponds to the given reference signal is equal to an RSRP or a L1-RSRP of the given reference signal.

In one subembodiment, a SINR or a L1-SINR of the given reference signal is used to determine a second-type received quality corresponding to the given reference signal.

In one subembodiment, a second-type received quality that corresponds to the given reference signal is equal to a SINR or a L1-SINR of the given reference signal.

In one subembodiment, a second-type received quality corresponding to the given reference signal is obtained by looking up the table of RSRP. L1-RSRP. SINR or L1-SINR for the given reference signal.

In one subembodiment, a second-type received quality corresponding to the given reference signal is obtained according to hypothetical PDCCH transmission parameters.

In one subembodiment, the given reference signal is any reference signal in the first reference signal subgroup and the second reference signal subgroup.

In one embodiment, the specific definition of the hypothetical PDCCH transmission parameters can be found in 3GPP TS38.133.

In one embodiment, the first reference signal subgroup and the second reference signal subgroup belong to a same serving cell, the first signal indicating an index of the same serving cell.

### Embodiment 14

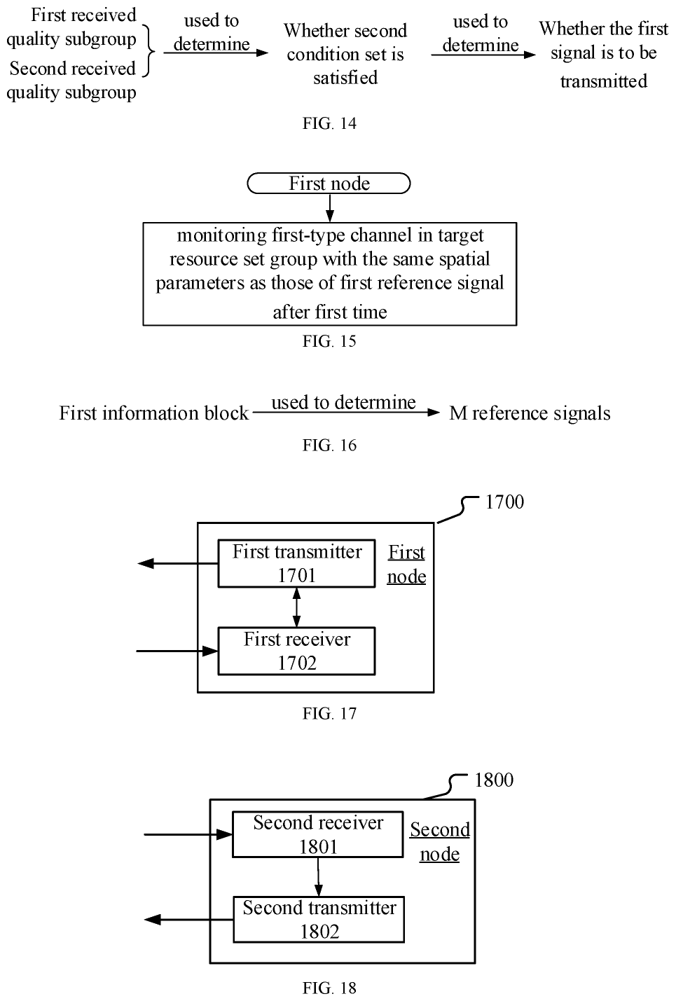

Embodiment 14 illustrates a schematic diagram of a first received quality subgroup, a second received quality subgroup, a second condition set and a first signal according to one embodiment of the present application: as shown in FIG. 14. In Embodiment 14, the first received quality subgroup and the second received quality subgroup are used to determine whether the second condition set is satisfied, and whether the second condition set is satisfied is used to determine whether the first signal is to be transmitted.

In one embodiment, the second condition set comprises a second condition and a third condition: the second condition set is satisfied when one of the second condition or the third condition is satisfied: the second condition set is not satisfied when neither the second condition nor the third condition is satisfied.

In one embodiment, the second condition set comprises a second condition and a third condition; whether the second condition and the third condition are both satisfied is used to determine the type of the channel carrying the first signal.

In one embodiment, the second condition comprises: each second-type received quality in the first received quality subgroup being worse than a second threshold: the third condition comprises: each second-type received quality in the second received quality subgroup being worse than a fourth threshold.

In one embodiment, the second condition comprises: each second-type received quality in the first received quality subgroup being no better than a second threshold: the third condition comprises: each second-type received quality in the second received quality subgroup being no better than a fourth threshold.

In one embodiment, the fourth threshold is equal to the second threshold.

In one embodiment, the fourth threshold is unequal to the second threshold.

In one embodiment, the second threshold is a real number.

In one embodiment, the second threshold is a non-negative real number.

In one embodiment, the second threshold is a non-negative real number no greater than 1.

In one embodiment, the second threshold is one of Q_{out_LR}, Q_{out_LR_SSB} Or Q_{out_LR_CSI-RS}.

In one embodiment, for definitions of the Q_{out_L}, Q_{out_LR_SSB} and Q_{out_LR_CSI-RS}, refer to 3GPP TS38.133.

In one embodiment, the second threshold is configured by a higher layer parameter, a name of the higher layer parameter configuring the second threshold including “rlmInSyncOutOfSyncThreshold”.

In one embodiment, the fourth threshold is a real number.

In one embodiment, the fourth threshold is a non-negative real number no greater than 1.

In one embodiment, the fourth threshold is configured by a higher layer parameter, a name of the higher layer parameter configuring the fourth threshold including “rlmInSyncOutOfSyncThreshold”.

In one embodiment, that a second-type received quality is worse/better than a threshold means that the second-type received quality is one of RSRP. L1-RSRP. SINR or L1-SINR, the second-type received quality being smaller/greater than the threshold.

In one embodiment, that a second-type received quality is worse/better than a threshold means that the second-type received quality is BLER, the second-type received quality being greater/smaller than the threshold.

In one embodiment, when the second condition set is satisfied, a physical layer of the first node transmits a beam failure instance indication to a higher layer of the first node: upon the reception of a beam failure instance indication from the physical layer of the first node, the higher layer of the first node increments the value of the first counter by 1.

In one embodiment, as a response to receiving a beam failure instance indication from a physical layer of the first node, a higher layer of the first node increments the value of the first counter by 1.

In one embodiment, the first counter is a BFI_COUNTER.

In one embodiment, a name of the first counter includes “BFI” and “COUNTER”.

In one embodiment, an initial value of the first counter is 0.

In one embodiment, a value of the first counter is a non-negative integer.

In one embodiment, the first signal is triggered when the value of the first counter is no less than a first counter threshold.

In one embodiment, the first signal is triggered as a response to the value of the first counter being no less than a first counter threshold.

In one embodiment, the first counter threshold is a positive integer.

In one embodiment, the first counter threshold is configured by a higher layer parameter, a name of the higher layer parameter configuring the first counter threshold including “beamFailureInstanceMaxCount”.

In one embodiment, the first counter threshold is equal to a higher layer parameter beamFailureInstanceMaxCount.

In one embodiment, when the second condition set is satisfied, whether only one of the second condition and the third condition is satisfied or both the second condition and the third condition are satisfied is used to determine the type of the channel carrying the first signal.

In one embodiment, when only one of the second condition and the third condition is satisfied, the channel carrying the first signal includes at least the former of PUSCH and PUCCH.

In one embodiment, when only one of the second condition and the third condition is satisfied, the channel carrying the first signal includes only PUSCH.

In one embodiment, when both of the second condition and the third condition are satisfied, the channel carrying the first signal includes only PRACH.

In one embodiment, when both of the second condition and the third condition are satisfied, the channel carrying the first signal includes at least the former of PRACH and PUSCH.

In one embodiment, when only one of the second condition and the third condition is satisfied, the first signal carries first sub-information, the first sub-information indicating which one of the second condition and the third condition is satisfied.

In one embodiment, when only one of the second condition and the third condition is satisfied, the first signal carries second sub-information, the second sub-information indicating whether the first signal indicates one of the M reference signals: when the second sub-information indicates that the first information indicates one of the M reference signals, the first signal comprises third sub-information, the third sub-information indicating the first reference signal.

### Embodiment 15

Embodiment 15 illustrates a schematic diagram of a first node monitoring a first-type channel in a target resource set group with the same spatial parameters as those of a first reference signal after first time according to one embodiment of the present application: as shown in FIG. 15. In Embodiment 15, the target resource set group is the first resource set group or the second resource set group; the first reference signal is used to determine the target resource set group.

In one embodiment, the sentence of monitoring the first-type channel in a target resource set group with same spatial parameters as those of the first reference signal is similar in meaning to the sentence of monitoring a first-type channel in a first resource subset with same spatial parameters as those of a target reference signal, except that the target reference signal is replaced with the first reference signal and the first resource subset is replaced with the target resource set group.

In one embodiment, the first node monitors the first-type channel with the same spatial parameters as those of the first reference signal after the first time in only the target resource set group of the first resource set group and the second resource set group.

In one embodiment, as a response to the action of receiving a first signaling, the first node monitors the first-type channel in the target resource set group with same spatial parameters as those of the first reference signal after the first time.

In one embodiment, the first node monitors the first-type channel in a resource set group different from the target resource set group between the first resource set group and the second resource set group after the first time.

In one embodiment, spatial parameters assumed by the first node after the first time for the first-type channel in a resource set group different from the target resource set group between the first resource set group and the second resource set group are unrelated to the first reference signal.

In one embodiment, each of the first resource set group and the second resource set group respectively comprises at least one resource set.

In one embodiment, any resource set in the first resource set group and the second resource set group occupies at least one symbol in time domain.

In one embodiment, any resource set in the first resource set group and the second resource set group occupies at least one PRB in time domain.

In one embodiment, any resource set in the first resource set group and the second resource set group comprises one CORESET.

In one embodiment, any resource set in the first resource set group and the second resource set group is a CORESET.

In one embodiment, any resource set in the first resource set group and the second resource set group comprises one search space set.

In one embodiment, any resource set in the first resource set group and the second resource set group comprises at least one PDCCH candidate.

In one embodiment, each of the first resource set group and the second resource set group respectively comprises all or partial PDCCH candidates and/or all or partial PDCCH monitoring occasions in at least one CORESET.

In one embodiment, each of the first resource set group and the second resource set group respectively comprises all or partial PDCCH candidates and/or all or partial PDCCH monitoring occasions in at least one search space set.

In one embodiment, there does not exist a CORESET belonging to both the first resource set group and the second resource set group.

In one embodiment, there does not exist a search space set belonging to both the first resource set group and the second resource set group.

In one embodiment, any PDCCH candidate in the first resource set group and any PDCCH candidate in the second resource set group belong to different CORESETs.

In one embodiment, any PDCCH candidate in the first resource set group and any PDCCH candidate in the second resource set group belong to different search space sets.

In one embodiment, the first resource set group and the second resource set group occur periodically in time domain, respectively.

In one embodiment, the first resource set group and the second resource set group belong to a same BWP.

In one embodiment, the first resource set group and the second resource set group belong to a same serving cell.

In one embodiment, the first resource set group and the second resource set group belong to different cells.

In one embodiment, the first resource set group, the second resource set group and the first resource subset belong to a same serving cell.

In one embodiment, the first resource set group and the second resource set group are overlapping in time domain.

In one embodiment, the first resource set group, the second resource set group and the first resource subset are mutually overlapping in time domain.

In one embodiment, neither of the first resource set group and the second resource set group comprises the first resource subset.

In one embodiment, neither of the first resource set group and the second resource set group comprises a CORESET to which the first resource subset belongs.

In one embodiment, neither of the first resource set group and the second resource set group comprises a CORESET with index 0.

In one embodiment, each of the first resource set group and the second resource set group respectively corresponds to a first-type index: the first-type index corresponding to the first resource set group is unequal to the first-type index corresponding to the second resource set group; the first-type index is a non-negative integer.

In one embodiment, a higher layer signaling is used to determine the first-type index corresponding to the first resource set group and the first-type index corresponding to the second resource set group.

In one embodiment, each resource set in the first resource set group and the second resource set group corresponds to a first-type index: first-type indexes corresponding to any two resource sets in the first resource set group are equal, and first-type indexes corresponding to any two resource sets in the second resource set group are equal: a first-type index corresponding to any resource set in the first resource set group is unequal to a first-type index corresponding to any resource set in the second resource set group.

In one embodiment, a higher layer signaling is used to determine the first-type index corresponding to each resource set in the first resource set group and the second resource set group.

In one embodiment, each resource set in the first resource set group is not configured with a third higher layer parameter or is configured with a third higher layer parameter set to a first integer: each resource set in the second resource set group is configured with a third higher layer parameter set to a second integer: the first integer is not equal to the second integer.

In one embodiment, for any resource set in the first resource set group and the second resource set group, if any resource set is configured with the third higher layer parameter, the first-type index corresponding to the any resource set is equal to the third higher layer parameter configured: if any resource set is not configured with the third higher layer parameter, the first-type index corresponding to the any resource set is equal to the first integer.

In one embodiment, the first reference signal subset corresponds to the first resource set group, while the second reference signal subset corresponds to the second resource set group.

In one embodiment, a value of the first-type index corresponding to the first resource set group is equal to that of the second-type index corresponding to the first reference signal subset; a value of the first-type index corresponding to the second resource set group is equal to that of the second-type index corresponding to the second reference signal subset.

In one embodiment, a value of the second-type index corresponding to the first reference signal subset is equal to that of the first-type index corresponding to any resource set in the first resource set group; a value of the second-type index corresponding to the second reference signal subset is equal to that of the first-type index corresponding to any resource set in the second resource set group.

In one embodiment, a value of the second-type index corresponding to the first reference signal subset is equal to the first integer: a value of the second-type index corresponding to the second reference signal subset is equal to the second integer.

In one embodiment, the first reference signal is used to determine whether the target resource set group is the first resource set group or the second resource set group.

In one embodiment, whether the first reference signal belongs to the first reference signal subset or the second reference signal subset is used to determine whether the target resource set group is the first resource set group or the second resource set group.

In one embodiment, when the first reference signal belongs to the first reference signal subset, the target resource set group is the first resource set group; when the first reference signal belongs to the second reference signal subset, the target resource set group is the second resource set group.

In one embodiment, the second node transmits the first-type channel in the target resource set group with the same spatial parameters as those of the first reference signal after the first time.

### Embodiment 16

Embodiment 16 illustrates a schematic diagram of a first information block being used to determine M reference signals according to one embodiment of the present application: as shown in FIG. 16.

In one embodiment, the first information block is carried by a higher layer signaling.

In one embodiment, the first information block is carried by an RRC signaling.

In one embodiment, the first information block is carried by a MAC CE signaling.

In one embodiment, the first information block is carried by an Information Element (IE).

In one embodiment, the first information block is carried by multiple IEs.

In one embodiment, the first information block is carried by multiple fields of one IE.

In one embodiment, a name of an IE carrying the first information block includes “BeamFailureRecovery”.

In one embodiment, the first information block is carried by a higher layer parameter, where a name of the higher layer parameter carrying the first information block includes “candidateBeamRS”.

In one embodiment, the first information block indicates the M reference signals.

In one embodiment, the first information block indicates the M reference signal identifiers.

In one embodiment, the first information block indicates an identifier of a BWP in which the M reference signals are located.

In one embodiment, the first information block indicates an identifier of a cell in which the M reference signals are located.

In one embodiment, the first information block indicates the first reference signal subset and the second reference signal subset.

In one embodiment, the first information block is used to determine that the first reference signal subset corresponds to the first resource set group, and the first information block is used to determine that the second reference signal subset corresponds to the second resource set group.

In one embodiment, the first information block is used to configure the second-type index corresponding to the first reference signal subset, and the first information block is used to configure the second-type index corresponding to the second reference signal subset.

In one embodiment, the first information block comprises a first information sub-block and a second information sub-block, the first information sub-block indicating the first reference signal subset, while the second information sub-block indicating the second reference signal subset.

In one embodiment, the first information sub-block indicates a reference signal identifier of each reference signal in the first reference signal subset, while the second information sub-block indicates a reference signal identifier of each reference signal in the second reference signal subset.

In one embodiment, the first information sub-block and the second information sub-block are respectively carried by two different fields of an IE.

In one embodiment, the first information sub-block and the second information sub-block are respectively carried by different IEs.

In one embodiment, the first information sub-block and the second information sub-block are respectively carried by different higher layer signalings.

In one embodiment, the first information sub-block is used to configure the second-type index corresponding to the first reference signal subset, while the second information sub-block is used to configure the second-type index corresponding to the second reference signal subset.

### Embodiment 17

Embodiment 17 illustrates a structure block diagram of a processing device used in a first node according to one embodiment of the present application, as shown in FIG. 17. In FIG. 17, a processing device 1700 in a first node comprises a first transmitter 1701 and a first receiver 1702.

In Embodiment 17, the first transmitter 1701 transmits a first signal: the first receiver 1702 receives a first signaling, and monitors a first-type channel in a first resource subset with the same spatial parameters as those of a target reference signal after first time.

In Embodiment 17, the first signal is used to indicate a first reference signal: the first signaling is used to determine the first time: the first reference signal is one of M reference signals. M being a positive integer greater than 1; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

In one embodiment, the first receiver 1702 monitors a second-type channel in a second resource set and detects the first signaling, the first signaling being transmitted in a second-type channel in the second resource set.

In one embodiment, the first receiver 1702 monitors the first-type channel in a second resource subset before the first time; herein, before the first time, the same spatial parameters as those of a second reference signal are assumed for the monitoring of the first-type channel in the second resource subset.

In one embodiment, the first receiver 1702 receives a second signaling in the first resource subset after the first time; herein, the second signaling comprises a second field, the value of the second field in the second signaling being related to a number of first-type signalings transmitted in a target resource set group, the target resource set group being a first resource set group or a second resource set group; the value of the second field in the second signaling is unrelated to a number of first-type signalings transmitted in a resource set group of the first resource set group and the second resource set group other than the target resource set group; when the target reference signal is the first reference signal, the first reference signal is used to determine the target resource set group.

In one embodiment, the first receiver 1702 receives a third signaling after the first time; herein, the third signaling comprises a MAC CE or a DCI; the third signaling comprises a third field and a fourth field, the third field in the third signaling indicating a given CORESET, and the fourth field in the third signaling indicating an index of a CORESET pool corresponding to the given CORESET.

In one embodiment, the M reference signals include a first reference signal subset and a second reference signal subset; when the type/types of the channel/channels carrying the first signal does/do not include the first type, whether the target reference signal is the first reference signal is related to whether the first reference signal belongs to the first reference signal subset or the second reference signal subset.

In one embodiment, the first receiver 1702 receives the M reference signals, measurements of the M reference signals being respectively used to determine M first-type received qualities; herein, the M first-type received qualities are used to determine the first reference signal.

In one embodiment, the M reference signals include a first reference signal subset and a second reference signal subset; when and only when a first condition is satisfied, the first reference signal belongs to the second reference signal subset; the first condition is related to a first-type received quality corresponding to each reference signal in the first reference signal subset.

In one embodiment, the first receiver 1702 receives a first reference signal subgroup and a second reference signal subgroup, a measurement of the first reference signal subgroup being used to determine a first received quality subgroup, while a measurement of the second reference signal subgroup being used to determine a second received quality subgroup, each of the first reference signal subgroup and the second reference signal subgroup respectively comprising at least one reference signal, and each of the first received quality subgroup and the second received quality subgroup respectively comprising at least one second-type received quality: where the first received quality subgroup and the second received quality subgroup are used to determine whether a second condition set is satisfied, and whether the second condition set is satisfied is used to determine whether the first signal is to be transmitted.

In one embodiment, the first receiver 1702 monitors the first-type channel in a target resource set group with same spatial parameters as those of the first reference signal after the first time: where the target resource set group is a first resource set group or a second resource set group; the first reference signal is used to determine the target resource set group.

In one embodiment, the first receiver 1702 receives a first information block; herein, the first information block is used to determine the M reference signals.

In one embodiment, the first signal comprises a PRACH preamble or a MAC CE, and the first signaling comprises a DCI; the channel carrying the first signal refers to a physical layer channel carrying the first signal: the first type is PRACH: a search space set to which the first signaling belongs is identified by a recovery SearchSpaceId or the first signal is transmitted in a first PUSCH and the first signaling schedules transmission of a PUSCH with the same HARQ process number and toggled NDI field value as the first PUSCH.

In one embodiment, the first node is a UE.

In one embodiment, the first node is a relay node.

In one embodiment, the first transmitter 1701 comprises at least one of the antenna 452, the transmitter 454, the transmitting processor 468, the multi-antenna transmitting processor 457, the controller/processor 459, the memory 460 or the data source 467 in Embodiment 4.

In one embodiment, the first receiver 1702 comprises at least one of the antenna 452, the receiver 454, the receiving processor 456, the multi-antenna receiving processor 458, the controller/processor 459, the memory 460 or the data source 467 in Embodiment 4.

### Embodiment 18

Embodiment 18 illustrates a structure block diagram of a processing device used in a second node according to one embodiment of the present application, as shown in FIG. 18. In FIG. 18, a processing device 1800 in the second node comprises a second receiver 1801 and a second transmitter 1802.

In Embodiment 18, the second receiver 1801 receives a first signal; the second transmitter 1802 transmits a first signaling, and transmits a first-type channel in a first resource subset after first time.

In Embodiment 18, the first signal is used to indicate a first reference signal: the first signaling is used to determine the first time: the first reference signal is one of M reference signals. M being a positive integer greater than 1: after the first time, a transmitter of the first signal monitors the first-type channel in the first resource subset with same spatial parameters as those of a target reference signal; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

In one embodiment, the second transmitter 1802 transmits the first-type channel in a second resource subset before the first time; herein, a transmitter of the first signal monitors the first-type channel in the second resource subset with same spatial parameters as those of a second reference signal before the first time.

In one embodiment, the second transmitter 1802 transmits a second signaling in the first resource subset after the first time; herein, the second signaling comprises a second field, the value of the second field in the second signaling being related to a number of first-type signalings transmitted in a target resource set group, the target resource set group being a first resource set group or a second resource set group; the value of the second field in the second signaling is unrelated to a number of first-type signalings transmitted in a resource set group of the first resource set group and the second resource set group other than the target resource set group; when the target reference signal is the first reference signal, the first reference signal is used to determine the target resource set group.

In one embodiment, the second transmitter 1802 transmits a third signaling after the first time; herein, the third signaling comprises a MAC CE or a DCI; the third signaling comprises a third field and a fourth field, the third field in the third signaling indicating a given CORESET, and the fourth field in the third signaling indicating an index of a CORESET pool corresponding to the given CORESET.

In one embodiment, the M reference signals include a first reference signal subset and a second reference signal subset; when the type/types of the channel/channels carrying the first signal does/do not include the first type, whether the target reference signal is the first reference signal is related to whether the first reference signal belongs to the first reference signal subset or the second reference signal subset.

In one embodiment, the second transmitter 1802 transmits the M reference signals, measurements of the M reference signals being respectively used to determine M first-type received qualities; herein, the M first-type received qualities are used to determine the first reference signal.

In one embodiment, the M reference signals include a first reference signal subset and a second reference signal subset; when and only when a first condition is satisfied, the first reference signal belongs to the second reference signal subset; the first condition is related to a first-type received quality corresponding to each reference signal in the first reference signal subset.

In one embodiment, the second transmitter 1802 transmits a first reference signal subgroup and a second reference signal subgroup, a measurement of the first reference signal subgroup being used to determine a first received quality subgroup, while a measurement of the second reference signal subgroup being used to determine a second received quality subgroup, each of the first reference signal subgroup and the second reference signal subgroup respectively comprising at least one reference signal, and each of the first received quality subgroup and the second received quality subgroup respectively comprising at least one second-type received quality: where the first received quality subgroup and the second received quality subgroup are used to determine whether a second condition set is satisfied, and whether the second condition set is satisfied is used to determine whether the first signal is to be transmitted.

In one embodiment, the second transmitter 1802 transmits the first-type channel in a target resource set group after the first time: where a transmitter of the first signal monitors the first-type channel in the target resource set group with same spatial parameters as those of the first reference signal after the first time: the target resource set group is a first resource set group or a second resource set group; the first reference signal is used to determine the target resource set group.

In one embodiment, the second transmitter 1802 transmits a first information block; herein the first information block is used to determine the M reference signals.

In one embodiment, the first signal comprises a PRACH preamble or a MAC CE, and the first signaling comprises a DCI; the channel carrying the first signal refers to a physical layer channel carrying the first signal: the first type is PRACH: a search space set to which the first signaling belongs is identified by a recovery SearchSpaceId or the first signal is transmitted in a first PUSCH and the first signaling schedules transmission of a PUSCH with the same HARQ process number and toggled NDI field value as the first PUSCH.

In one embodiment, the device in the second node is a base station.

In one embodiment, the device in the second node is a UE.

In one embodiment, the device in the second node is a relay node.

In one embodiment, the second receiver 1801 comprises at least one of the antenna 420, the receiver 418, the receiving processor 470, the multi-antenna receiving processor 472, the controller/processor 475 or the memory 476 in Embodiment 4.

In one embodiment, the second transmitter 1802 comprises at least one of the antenna 420, the transmitter 418, the transmitting processor 416, the multi-antenna transmitting processor 471, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles. RSU, wireless sensor, network cards, terminals for Internet of Things (IOT). RFID terminals. NB-IOT terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, eNB, gNB, Transmitter Receiver Point (TRP). GNSS, relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first transmitter, transmitting a first signal, the first signal used to indicate a first reference signal; and
a first receiver, receiving a first signaling, the first signaling used to determine a first time;
the first receiver, monitoring a first-type channel in a first resource subset with same spatial parameters as those of a target reference signal after the first time, the first-type channel being a Physical Downlink Control Channel (PDCCH);
wherein the first reference signal is one of M reference signals, M being a positive integer greater than 1; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

2. The first node according to claim 1, characterized in that the M reference signals include a first reference signal subset and a second reference signal subset; when the type/types of the channel/channels carrying the first signal does/do not include the first type, whether the target reference signal is the first reference signal is related to whether the first reference signal belongs to the first reference signal subset or the second reference signal subset; when the type/types of the channel/channels carrying the first signal does/do not include the first type and the first reference signal belongs to the first reference signal subset, the target reference signal is the first reference signal; when the type/types of the channel/channels carrying the first signal does/do not include the first type and the first reference signal belongs to the second reference signal subset, the target reference signal is a second reference signal.

3. The first node according to claim 2, characterized in that the second reference signal is configured by a Radio Resource Control (RRC) signaling, or, the second reference signal is indicated by a MAC Control Element (CE).

4. The first node according to claim 1, characterized in that the first type is Physical Random Access Channel (PRACH).

5. The first node according to claim 1, characterized in that the first resource subset is a Control Resource Set (CORESET) with an index 0.

6. The first node according to claim 1, characterized in that a search space set to which the first signaling belongs is related to the type/types of the channel/channels carrying the first signal.

7. The first node according to claim 1, characterized in that the first receiver receives a first reference signal subgroup and a second reference signal subgroup, a measurement of the first reference signal subgroup being used to determine a first received quality subgroup, while a measurement of the second reference signal subgroup being used to determine a second received quality subgroup, each of the first reference signal subgroup and the second reference signal subgroup respectively comprising at least one reference signal, and each of the first received quality subgroup and the second received quality subgroup respectively comprising at least one second-type received quality: where the first received quality subgroup and the second received quality subgroup are used to determine whether a second condition set is satisfied, and whether the second condition set is satisfied is used to determine whether the first signal is to be transmitted.

8. The first node according to claim 1, characterized in that the first receiver monitors the first-type channel in a target resource set group with same spatial parameters as those of the first reference signal after the first time; where the target resource set group is a first resource set group or a second resource set group; the first reference signal is used to determine the target resource set group.

9. A second node for wireless communications, characterized in comprising:
a second receiver, receiving a first signal, the first signal used to indicate a first reference signal; and
a second transmitter, transmitting a first signaling, the first signaling used to determine a first time;
the second transmitter, transmitting a first-type channel in a first resource subset after the first time, the first-type channel being a Physical Downlink Control Channel (PDCCH);
wherein the first reference signal is one of M reference signals, M being a positive integer greater than 1; after the first time, a transmitter of the first signal monitors the first-type channel in the first resource subset with same spatial parameters as those of a target reference signal; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

10. The second node according to claim 9, characterized in that the M reference signals include a first reference signal subset and a second reference signal subset; when the type/types of the channel/channels carrying the first signal does/do not include the first type, whether the target reference signal is the first reference signal is related to whether the first reference signal belongs to the first reference signal subset or the second reference signal subset; when the type/types of the channel/channels carrying the first signal does/do not include the first type and the first reference signal belongs to the first reference signal subset, the target reference signal is the first reference signal; when the type/types of the channel/channels carrying the first signal does/do not include the first type and the first reference signal belongs to the second reference signal subset, the target reference signal is a second reference signal.

11. The second node according to claim 9, characterized in that the first type is Physical Random Access Channel (PRACH).

12. The second node according to claim 9, characterized in that the first resource subset is a Control Resource Set (CORESET) with an index 0.

13. The second node according to claim 9, characterized in that the second transmitter performs at least one of:
transmitting a first reference signal subgroup and a second reference signal subgroup, a measurement of the first reference signal subgroup being used to determine a first received quality subgroup, while a measurement of the second reference signal subgroup being used to determine a second received quality subgroup, each of the first reference signal subgroup and the second reference signal subgroup respectively comprising at least one reference signal, and each of the first received quality subgroup and the second received quality subgroup respectively comprising at least one second-type received quality; where the first received quality subgroup and the second received quality subgroup are used to determine whether a second condition set is satisfied, and whether the second condition set is satisfied is used to determine whether the first signal is to be transmitted; or
transmitting the first-type channel in a target resource set group after the first time; where the transmitter of the first signal monitors the first-type channel in the target resource set group with same spatial parameters as those of the first reference signal after the first time; the target resource set group is a first resource set group or a second resource set group; the first reference signal is used to determine the target resource set group.

14. A method in a first node for wireless communications, characterized in comprising:
transmitting a first signal, the first signal used to indicate a first reference signal;
receiving a first signaling, the first signaling used to determine a first time; and
monitoring a first-type channel in a first resource subset with same spatial parameters as those of a target reference signal after the first time, the first-type channel being a Physical Downlink Control Channel (PDCCH);
wherein the first reference signal is one of M reference signals, M being a positive integer greater than 1; whether the target reference signal is the first reference signal is related to a type/types of a channel/channels carrying the first signal; when the type/types of the channel/channels carrying the first signal includes/include a first type, the target reference signal is the first reference signal; when the type/types of the channel/channels carrying the first signal does/do not include the first type, whether the target reference signal is the first reference signal is related to the first reference signal.

15. The method in the first node according to claim 14, characterized in that the M reference signals include a first reference signal subset and a second reference signal subset; when the type/types of the channel/channels carrying the first signal does/do not include the first type, whether the target reference signal is the first reference signal is related to whether the first reference signal belongs to the first reference signal subset or the second reference signal subset; when the type/types of the channel/channels carrying the first signal does/do not include the first type and the first reference signal belongs to the first reference signal subset, the target reference signal is the first reference signal; when the type/types of the channel/channels carrying the first signal does/do not include the first type and the first reference signal belongs to the second reference signal subset, the target reference signal is a second reference signal.

16. The method in the first node according to claim 15, characterized in that the second reference signal is configured by a Radio Resource Control (RRC) signaling, or, the second reference signal is indicated by a MAC Control Element (CE).

17. The method in the first node according to claim 14, characterized in that the first type is Physical Random Access Channel (PRACH).

18. The method in the first node according to claim 14, characterized in that the first resource subset is a Control Resource Set (CORESET) with an index 0.

19. The method in the first node according to claim 14, characterized in that a search space set to which the first signaling belongs is related to the type/types of the channel/channels carrying the first signal.

20. The method in the first node according to claim 14, characterized in comprising at least one of:
receiving a first reference signal subgroup and a second reference signal subgroup, a measurement of the first reference signal subgroup being used to determine a first received quality subgroup, while a measurement of the second reference signal subgroup being used to determine a second received quality subgroup, each of the first reference signal subgroup and the second reference signal subgroup respectively comprising at least one reference signal, and each of the first received quality subgroup and the second received quality subgroup respectively comprising at least one second-type received quality: where the first received quality subgroup and the second received quality subgroup are used to determine whether a second condition set is satisfied, and whether the second condition set is satisfied is used to determine whether the first signal is to be transmitted; or
monitoring the first-type channel in a target resource set group with same spatial parameters as those of the first reference signal after the first time; where the target resource set group is a first resource set group or a second resource set group; the first reference signal is used to determine the target resource set group.
